(19) United States
(12) Patent Application Publication
(10) Pub. No.: US 2019/0317530 A1
(43) Pub. Date: Oct. 17, 2019

(54) SYSTEMS AND METHODS OF UNMANNED AERIAL VEHICLE FLIGHT RESTRICTION FOR STATIONARY AND MOVING OBJECTS

(71) Applicant: SZ DJI TECHNOLOGY CO., LTD., Shenzhen (CN)

(72) Inventors: Bingzhen YANG, Shenzhen (CN); Guofang ZHANG, Shenzhen (CN); Tao WANG, Shenzhen (CN); Chang GENG, Shenzhen (CN)

(21) Appl. No.: 16/428,951

(22) Filed: May 31, 2019

Related U.S. Application Data
(63) Continuation of application No. PCT/CN2016/108228, filed on Dec. 1, 2016.

(51) Int. Cl. G05D 1/10; G08G 5/00

(52) U.S. Cl. CPC G05D 1/106; G08G 5/045; G08G 5/0069; G08G 5/006

(57) ABSTRACT

A method for controlling flight of an unmanned aerial vehicle (UAV) includes obtaining information about a location of an object of interest, and calculating, during operation of the UAV, a flight-restricted distance for the UAV to maintain relative to the object of interest. The flight-restricted distance is calculated based on a safety factor and the safety factor is determined based on an object classification. The method further includes controlling flight of the UAV to maintain the flight-restricted distance relative to the object of interest.

### CROSS-REFERENCE TO RELATED APPLICATION

This application is a continuation of International Application No. PCT/CN2016/108228, filed on Dec. 1, 2016, the entire content of which is incorporated herein by reference.

### BACKGROUND OF THE DISCLOSURE

Aerial vehicles such as unmanned aerial vehicles (UAVs) can be used for performing surveillance, reconnaissance, and exploration tasks for military and civilian applications. Such vehicles may carry a payload configured to perform a specific function.

The air traffic control of every country (e.g., the Federal Aviation Association (FAA) in the United States) has various regulations for airspace near stationary objects (e.g., airports or other buildings or regions) or moving objects. For example, within a certain distance of an airport, all UAVs are prohibited from flying, no matter what altitude or range of the UAV. That is to say, it is illegal to fly UAVs within a certain distance of an airport because of safety concerns. There may be similar restrictions near sensitive buildings such as nuclear plants.

### SUMMARY OF THE DISCLOSURE

A need exists for improved systems and methods for unmanned aerial vehicle (UAV) flight restrictions and control. A further need exists for dynamic flight restriction for UAVs to avoid moving objects. UAV flight restriction systems may be implemented on based on a geographical position signal. However, the accuracy of a geographical position signal is not always guaranteed, regardless of the source of the location signal (GNSS system, public phone network, or ground radar positioning networks). For various stationary objects, it may be challenging to restrict the flight of a UAV by defining stationary flight restriction zones in advance. Similarly, for moving objects, it may be challenging to define corresponding flight restriction zones in advance. Therefore, there is a need to provide a scheme to prevent stationary and moving objects from the dangers posed by UAVs by maintaining at least a flight-restriction distance between them.

In some instances, it may be desirable to control flight of an aerial vehicle, such as a UAV, to permit response to detected flight-restriction regions corresponding to stationary objects (e.g., airports or other buildings) or moving objects (e.g., manned vehicles). Thus, a need exists for improved flight control for flight-restriction regions corresponding to these stationary or moving objects. The present disclosure provides systems, methods, and devices related to detecting and responding to stationary or moving flight-restriction regions. Relative locations between a UAV and one or more flight-restriction regions (which may correspond to one or more stationary objects and/or moving objects) may be determined. Based on this information, a flight response of the UAV may be implemented, such as landing the UAV immediately, providing some time for the UAV to land, and/or providing an alert or warning of the proximity of the flight-restriction region.

An aspect of the disclosure is directed to a method for controlling flight of an unmanned aerial vehicle (UAV), the method comprising: obtaining information about a location of an object of interest; calculating, during operation of the UAV, a flight-restriction distance for the UAV to maintain relative to the object of interest, wherein the flight-restriction distance is calculated based on a safety factor, wherein the safety factor is determined based on an object classification; and controlling the UAV to maintain at least the flight-restriction distance relative to the object of interest.

An aspect of the disclosure is directed to an apparatus for controlling flight of an unmanned aerial vehicle (UAV), the apparatus comprising one or more processors configured to: obtain information about a location of an object of interest; calculate, during operation of the UAV, a flight-restriction distance for the UAV to maintain relative to the object of interest, wherein the flight-restriction distance is calculated based on a safety factor, wherein the safety factor is determined based on an object classification; and generate instructions that control the UAV to maintain at least the flight-restriction distance relative to the object of interest.

In an embodiment, the object classification is indicative of a type of objects of interest. The type of objects of interest is selected from a plurality of types of objects of interest. The plurality of types of objects of interest comprises stationary objects and moving objects. The plurality of types of objects of interest comprises types of structures or types of vehicles.

In an embodiment, the object classification is indicative of a movement characteristic of the object of interest. The safety factor is provided as a value, which corresponds to the object of interest's speed capability.

In an embodiment, the object of interest classification is indicative of a level of priority associated with the object of interest. The safety factor is provided as a value, which corresponds to the level of priority.

In an embodiment, the flight-restriction distance is calculated as a weighted combination of one or more of: (i) a distance safety margin; (ii) a maximum deviation in the UAV's location data; (iii) a maximum deviation in the object of interest's location data; (iv) a required minimum distance between the UAV and the object of interest; and (v) a braking distance needed to stop the UAV. In an embodiment, the weighted combination is calculated based on the safety factor.

In an embodiment, the flight-restriction distance is a vertical distance for the UAV to maintain relative to the object of interest, wherein the safety factor is a vertical safety factor determined based on the object classification. The vertical distance is calculated as a weighted combination of one or more of: (i) a vertical safety margin; (ii) a maximum deviation in the UAV's height data; (iii) a maximum deviation in the object of interest's height data; (iv) a required minimum vertical distance between the UAV and the object of interest; and (v) a vertical braking distance needed to stop the UAV. In an embodiment, the weighted combination is calculated based on the safety factor.

In an embodiment, the flight-restriction distance is indicative of a distance to a boundary of a flight-restriction region surrounding the object of interest. In an embodiment, the boundary of the flight restriction regions surrounding the object of interest is variable.

In an embodiment, the information about the location of the object of interest is broadcast from the object of interest at one or more time points. In an embodiment, the broadcasting is performed by an automatic dependent surveillance—broadcast (ADS-B) system.

In an embodiment, the information about the location of the object of interest comprises one or more of: latitude, longitude, altitude, speed, and direction, the information associated with the location of the object of interest at a time point. In an embodiment, the latitude, longitude, and/or altitude of the object of interest are provided based on information received from one or more of: a global navigation satellite system (GNSS), a mobile communication network, a low-altitude radar system, an altimeter, or a barometer. In an embodiment, the GNSS comprises a global positioning system (GPS), a BeiDou navigation satellite system, a GLONASS navigation satellite system, or a Galileo navigation satellite system.

In an embodiment, the step of calculating is performed by one or more processors on-board the UAV. In an embodiment, the step of calculating is performed by one or more processors off-board the UAV.

In an embodiment, the object of interest is a moving object with a speed relative to the ground.

In an embodiment, the object of interest is a stationary object with substantially zero range of motion.

In an embodiment, operation of the UAV comprises flight of the UAV.

In an embodiment, the step of maintaining at least the flight-restriction distance relative to the object of interest comprises obtaining information about a location of the UAV. In an embodiment, the information about the location of the UAV comprises one or more of: latitude, longitude, altitude, speed, and direction, the information associated with the location of the UAV at a time point. In an embodiment, the latitude, longitude, and/or altitude of the UAV are provided based on information received from one or more of: a global navigation satellite system (GNSS), a mobile communication network, a low-altitude radar system, an altimeter, or a barometer. In an embodiment, the GNSS comprises a global positioning system (GPS), a BeiDou navigation satellite system, a GLONASS navigation satellite system, or a Galileo navigation satellite system.

An aspect of the disclosure is directed to a method for controlling flight of an unmanned aerial vehicle (UAV), the method comprising: obtaining information about a location of an object of interest;

calculating, during operation of the UAV, a flight-restriction distance for the UAV to maintain relative to the object of interest, wherein the flight-restriction distance is calculated based on (1) a communication delay between the object of interest and the UAV, or (2) a data acquisition delay at the object of interest in providing the information about the location of the object of interest; and controlling the UAV to maintain at least the flight-restriction distance relative to the object of interest.

An aspect of the disclosure is directed to an apparatus for controlling flight of an unmanned aerial vehicle (UAV), the apparatus comprising: one or more processors configured to: obtaining information about a location of an object of interest; calculating, during operation of the UAV, a flight-restriction distance for the UAV to maintain relative to the object of interest, wherein the flight-restriction distance is calculated based on (1) a communication delay between the object of interest and the UAV, or (2) a data acquisition delay at the object of interest in providing the information about the location of the object of interest; and generate instructions that control the UAV to maintain at least the flight-restriction distance relative to the object of interest.

In an embodiment, the communication delay comprises an amount of time required to transmit information about a location of the object of interest to the UAV. In an embodiment, the amount of time depends on a bandwidth of a communication channel between the object of interest and the UAV through which the information about the location is transmitted. In an embodiment, the data acquisition delay comprises an amount of time required to obtain information about a location of the object of interest. In an embodiment, the amount of time required to obtain the information about the location of the object of interest includes one or more of: an amount of time for a measurement module to measure the parameters of the object of interest, an amount of time for a receiving module to receive external signals, and an amount of time for a control module to decide which parameters are to be broadcast from the object of interest.

In an embodiment, the flight-restriction distance is calculated based on a sum of the communication delay and the data acquisition delay. In an embodiment, the flight-restriction distance is calculated further based on a velocity of the object of interest. In an embodiment, the flight-restriction distance is calculated further based on response time or maneuverability of the UAV. In an embodiment, the flight-restriction distance is calculated further based on a velocity of the UAV. In an embodiment, the flight-restriction distance is calculated further based on a projected direction of travel for the UAV or the object of interest. In an embodiment, the flight-restriction distance is indicative of a distance to a boundary of a flight-restriction region surrounding the object of interest. In an embodiment, the boundary of the flight restriction regions surrounding the object of interest is variable.

In an embodiment, the information about the location of the object of interest is broadcast from the object of interest at one or more time points. In an embodiment, the broadcasting is performed by an automatic dependent surveillance—broadcast (ADS-B) system.

In an embodiment, the information about the location of the object of interest comprises one or more of: latitude, longitude, altitude, speed, and direction, the information associated with the location of the object of interest at a time point.

An aspect of the disclosure is directed to a method for controlling flight of an unmanned aerial vehicle (UAV), the method comprising: obtaining information about a location of an object of interest;

calculating, during operation of the UAV, a flight-restriction distance for the UAV to maintain relative to the object of interest, wherein the flight-restriction distance is calculated based on a deviation estimated between the information about the location of the object of interest and a predetermined range of location of the object of interest; and controlling the UAV to maintain at least the flight-restriction distance relative to the object of interest.

An aspect of the disclosure is directed to an apparatus for controlling flight of an unmanned aerial vehicle (UAV), the apparatus comprising: one or more processors configured to:

obtain information about a location of an object of interest; calculate, during operation of the UAV, a flight-restriction distance for the UAV to maintain relative to the object of interest, wherein the flight-restriction distance is calculated based on a deviation estimated between the information about the location of the object of interest and a predetermined range of location of the object of interest; and generate instructions that control the UAV to maintain at least the flight-restriction distance relative to the object of interest.

In an embodiment, the object of interest is a stationary object with a substantially zero range of location. In an embodiment, the information about the location of the object of interest has a non-zero drift between two or more time points. In an embodiment, the information about the location of the object of interest is indicative of a speed relative to the ground of the stationary object. In an embodiment, the information about the location of the object of interest determines an expectation of a maximum deviation of the information about the apparent location of the object of interest. In an embodiment, the flight-restriction distance is calculated by setting the stationary object's detected speed to zero to differentiate the object of interest from a moving object.

In an embodiment, the object of interest is a moving object with a speed relative to the ground, wherein the speed has a predetermined range of location. In an embodiment, the predetermined range of location of the speed is based on the object of interest's classification. In an embodiment, the predetermined range of location of the speed is based on the object of interest's operational status. In an embodiment, the predetermined range of location of the speed is based on the object of interest's expected flight path. In an embodiment, the information about the location of the object of interest is indicative of an apparent speed of the moving object beyond the predetermined range of location of the speed of the object of interest. In an embodiment, the information about the location of the object of interest determines an expectation of a maximum deviation of the apparent speed of the object of interest. In an embodiment, the flight-restriction distance is calculated by setting the moving object's detected speed to the maximum speed in the predetermined range of location of the speed of the object of interest.

An aspect of the disclosure is directed to a method for controlling flight of an unmanned aerial vehicle (UAV), the method comprising: obtaining an indication of loss of communication with the object of interest; calculating a predicted path of the object of interest based on previously acquired information about one or more locations of the object of interest; updating, during the operation of the UAV, a flight-restriction distance for the UAV to maintain relative to the object of interest, based on the predicted path of the object of interest; and controlling the UAV to maintain at least the flight-restriction distance relative to the object of interest.

An aspect of the disclosure is directed to an apparatus for controlling flight of an unmanned aerial vehicle (UAV), the apparatus comprising: one or more processors configured to:

obtain an indication of loss of communication with the object of interest; calculate a predicted path of the object of interest based on previously acquired information about one or more locations of the object of interest; update, during the operation of the UAV, a flight-restriction distance for the UAV to maintain relative to the object of interest, based on the predicted path of the object of interest; and generate instructions that control the UAV to maintain at least the flight-restriction distance relative to the object of interest.

In an embodiment, the location of the unmanned aerial vehicle can be assessed with aid of a GPS signal at the unmanned aerial vehicle. The location of the flight-restriction region can be assessed by accessing a local memory of unmanned aerial vehicle which includes locations for one or more flight-restriction regions (e.g., airports). The local memory may be updated with the locations of one or more flight-restriction regions when the unmanned aerial vehicle communicates with an external device via a wired or wireless connection. In some instances, the local memory is updated with the locations of one or more flight-restriction regions when the unmanned aerial vehicle communicates with a communication network.

The flight-restriction region may be a stationary object (e.g., airport or other building) or a moving object (e.g., a plane, a train, a car, or other manned or unmanned vehicle).

Various aspects of the disclosure described herein may be applied to any of the particular applications set forth below or for any other types of moving objects. Any description herein of aerial vehicles, such as unmanned aerial vehicles, may apply to and be used for any moving object, such as any vehicle. Additionally, the systems, devices, and methods disclosed herein in the context of aerial motion (e.g., flight) may also be applied in the context of other types of motion, such as movement on the ground or on water, underwater motion, or motion in space. Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings (also “Figure” and “FIG.” herein), of which:

FIG. 1 illustrates an example of a flight-restriction region of a UAV, in accordance with an embodiment of the disclosure.

FIG. 2 illustrates an object-based unmanned aerial vehicle (UAV) flight restriction system, in accordance with an embodiment of the disclosure.

FIG. 3 illustrates an object-based unmanned aerial vehicle (UAV) flight restriction system, in accordance with another embodiment of the disclosure.

FIG. 4 illustrates examples of flight-restriction distances a UAV from another UAV, a manned vehicle, and a stationary object, in accordance with an embodiment of the disclosure.

FIG. 5 shows examples of delay times in communications between an object of interest and a UAV, in accordance with an embodiment of the disclosure.

FIG. 6 illustrates an example of a flight-restriction distance and altitude of a UAV from an object of interest moving away from the UAV, in accordance with an embodiment of the disclosure.

FIG. 7 illustrates an example of a predicted flight-restriction region of a UAV during loss of communication, in accordance with an embodiment of the disclosure.

FIG. 8 shows a computer control system that is programmed or otherwise configured to implement methods provided herein.

FIG. 9 illustrates an unmanned aerial vehicle (UAV), in accordance with an embodiment of the disclosure.

FIG. 10 illustrates a UAV, including a carrier and a payload, performing wireless communication with an object of interest.

FIG. 11 illustrates a schematic by way of block diagram of a system for controlling a UAV, in accordance with an embodiment of the disclosure.

### DETAILED DESCRIPTION OF THE EMBODIMENTS

Systems, methods, and devices are provided for flight control for an aerial vehicle in response to flight-restriction regions corresponding to one or more stationary or moving objects. The aerial vehicle may be an unmanned aerial vehicle (UAV). Flight of the UAV may be controlled to continually comply with restrictions of the flight-restriction regions corresponding to these objects of interest.

A geographical position, a height, a speed, a direction, an identity or type information of a stationary object or a moving object may be determined. Such information may be conveyed to a UAV. For example, a UAV may receive a wireless message transmitted from the stationary object or moving object. The flight restriction zones of a UAV can be generated and updated by combining real-time information of a stationary object or moving object with a UAV's position, speed, height, maximum flight speed, and other information. Flight restriction algorithms may generate a flight restriction distance that may define a boundary of a flight restriction zone.

The flight restriction distance may be determined based on a number of factors, such as timing factors. Timing factors may include time that an object of interest may need to determine and/or transmit information, timing of transmission from an object of interest to a UAV, and timing of processes that may occur on-board a UAV. The flight restriction distance may take in one or more safety factors into account, which may depend on characteristics of the object of interest and/or moving object. These considerations may provide a more controlled way of creating a flight restriction region. Advantageously, flight restriction regions may be dynamic to take into account up-to-date information about the object of interest and/or the UAV. This may provide improved safety qualifications while still allowing a UAV a reasonable degree of freedom.

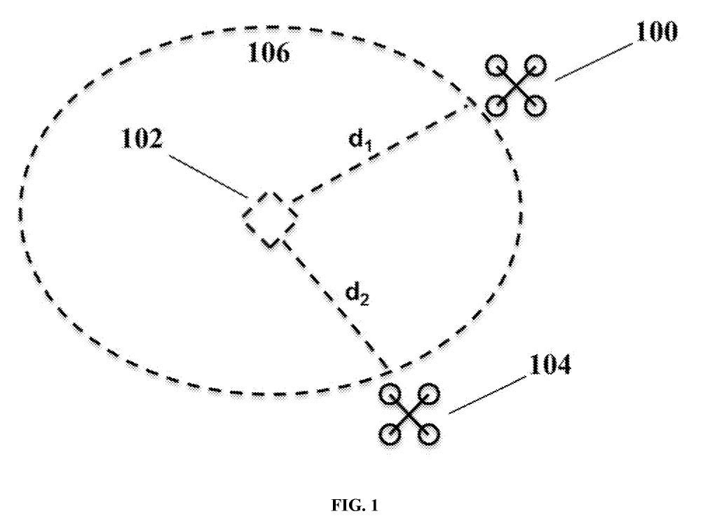

FIG. 1 shows an example of a flight restriction region in accordance with embodiments of the disclosure. An object of interest 102 may be provided. Flight of one or more UAVs 100, 104 may be controlled relative to the object of interest. In some embodiments, a flight restriction distance d₁, d₂ may be provided. The UAV may be required to maintain at least the flight restriction distance away from the object of interest. In some embodiments, flight-restriction distances may define a flight-restriction zone 106 for the object of interest.

An object of interest 102 may be a stationary object or a moving object. The object of interest may be stationary or moving relative to a reference frame. The reference frame can be a relatively fixed reference frame (e.g., the surrounding environment, or earth). Alternatively, the reference frame can be a moving reference frame (e.g., a moving vehicle). The UAV may continuously maintain flight control in order to avoid the object of interest (e.g., avoid a collision).

A stationary object may be non-moving. The stationary object may have a moving speed of substantially zero in latitude, longitude, and altitude (e.g., V=0). The stationary object may have a linear velocity, linear acceleration, angular velocity, and/or angular acceleration of zero. The stationary object may be stationary with respect to an inertial frame. An inertial frame may be an environment within which the object of interest is disposed. The inertial reference frame may be the Earth. A stationary object may be affixed with respect to the inertial reference frame. Alternatively, the stationary object may be capable of moving relative to the inertial reference frame, but may be non-moving at the moment. In some embodiments, a stationary object may not be capable of moving on its own power. The stationary object may require aid of another object in order to move. A stationary object may remain substantially stationary within an environment. Examples of stationary objects may include, but are not limited to landscape features (e.g., trees, plants, mountains, hills, rivers, streams, creeks, valleys, boulders, rocks, etc.) or manmade features (e.g., structures, buildings, roads, bridges, poles, fences, unmoving vehicles, signs, lights, etc.). Stationary objects may include large objects of interest or small objects of interest. In some instances, the stationary object may correspond to a selected portion of a structure or physical item.

A moving object may move with respect to one, two, or three axes. The moving object may move linearly with respect to one, two, or three axes, and/or may rotate about one, two or three axes. The axes may orthogonal to one another. The axes may include a yaw, pitch, and/or roll axis. The axes may be along a latitude, longitude, and/or altitude direction. The moving object may have a moving speed that is non-zero (e.g., V≠0). The moving speed may be non-zero with respect to one, two or three axes. The moving object may move with respect to an inertial reference frame. A moving object may be capable of moving with respect to the inertial reference frame. The moving object may actually be in motion with respect to the inertial reference frame. The moving object may be capable of moving on its own power. The moving object may be capable of self-propulsion.

A moving object may be capable of moving within the environment. The moving object may always be in motion, or may be at motions for portions of a time. For example, the moving object may be a car that may stop at a red light and then resume motion, or may be a train that may stop at a station and then resume motion. The moving object may move in a fairly steady direction or may change direction. The moving object may move in the air, on land, underground, on or in the water, and/or in space. The moving object may be a living moving object (e.g., human, animal) or a non-living moving object (e.g., moving vehicle, moving machinery, object blowing in wind or carried by water, object carried by living target). Moving objects may be large objects of interest or small objects of interest. A moving object may be any object of interest configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle; a movable structure or frame such as a stick, fishing pole; or a train), under the ground (e.g., a subway), in space (e.g., a spaceplane, a satellite, or a probe), or any combination of these environments.

A moving object may be capable of moving freely within the environment with respect to six degrees of freedom (e.g., three degrees of freedom in translation and three degrees of freedom in rotation). Alternatively, the movement of the moving object can be constrained with respect to one or more degrees of freedom, such as by a predetermined path, track, or orientation. The movement can be actuated by any suitable actuation mechanism, such as an engine or a motor. The actuation mechanism of the moving object can be powered by any suitable energy source, such as electrical energy, magnetic energy, solar energy, wind energy, gravitational energy, chemical energy, nuclear energy, or any suitable combination thereof. The moving object may be self-propelled via a propulsion system, such as described further below. The propulsion system may optionally run on an energy source, such as electrical energy, magnetic energy, solar energy, wind energy, gravitational energy, chemical energy, nuclear energy, or any suitable combination thereof.

In some instances, the moving object can be a vehicle, such as a remotely controlled vehicle. Suitable vehicles may include water vehicles, aerial vehicles, space vehicles, or ground vehicles. For example, aerial vehicles may be fixed-wing aircraft (e.g., airplane, gliders), rotary-wing aircraft (e.g., helicopters, rotorcraft), aircraft having both fixed wings and rotary wings, or aircraft having neither (e.g., blimps, hot air balloons). A vehicle can be self-propelled, such as self-propelled through the air, on or in water, in space, or on or under the ground. A self-propelled vehicle can utilize a propulsion system, such as a propulsion system including one or more engines, motors, wheels, axles, magnets, rotors, propellers, blades, nozzles, or any suitable combination thereof. In some instances, the propulsion system can be used to enable the moving object to take off from a surface, land on a surface, maintain its current position and/or orientation (e.g., hover), change orientation, and/or change position.

The object of interest may be live subjects such as people or animals and/or a vehicle carrying the live subjects, e.g., a limousine carrying a president or other government official, or a car carrying a VIP. The live subjects can include people or animals. For example, the object of interest may be an important person, such as a government official. The object of interest may be a person of specialized status. In some embodiments, a person of specialized status may experience elevated security risks and/or precautions.

In various embodiments, the object of interest may include a passive object or an active object. An active object may be configured to transmit information about the object of interest, such as the object of interest's GPS location. The information may be transmitted to a UAV, server, or any other type of external device. Information may be transmitted via wireless communication from a communication unit of the active target to a communication unit of the external device, such as a UAV. A passive object is not configured to transmit information about the object of interest.

An object of interest be at a region or area within an environment. The object of interest may be a physical item within an environment. The object of interest may or may not be visually distinguishable from its surroundings. An object of interest may be any natural or man-made objects or structures such geographical landscapes (e.g., mountains, vegetation, valleys, lakes, or rivers), buildings, vehicles (e.g., aircrafts, ships, cars, trucks, buses, vans, or motorcycle). An object of interest may be an active object or may be associated or affixed to an active object.

An object of interest may be a beacon that may provide information about an object. The object of interest may have an associated beacon that may be integral to the object of interest, may be affixed to the object of interest, or may be separable from the object of interest. The beacon may be removably attached to the object of interest, or may be a completely separate from the object of interest. The beacon may be the object of interest, and vice versa. The beacon may be provided at the same location or separate location as the object of interest.

An object of interest may have an associated flight-restriction region 106. An object of interest may be within the associated flight-restriction region. The flight-restriction region may encompass the object of interest. The object of interest may be a physical location, or a structure, landmark, feature, transportable item, vehicle, or any other type of object. An object of interest may comprise, or be placed at, one or more locations such as, but not limited to, airports, flight corridors, military or other government facilities, locations near sensitive personnel (e.g., when the President or other leader is visiting a location), vehicles carrying sensitive personnel or cargo, nuclear sites, research facilities, private airspace, de-militarized zones, certain jurisdictions (e.g., townships, cities, counties, states/provinces, countries, bodies of water or other natural landmarks), national borders (e.g., the border between the U.S. and Mexico), or other types of no-fly zones. Associated flight-restriction regions may be provided accordingly. In some embodiments, an active object, such as a beacon, may transmit information that is used to determine a flight-restriction region.

A UAV 100, 104 may be prevented from entering a flight-restriction region 106. Any description herein of a UAV may apply to any type of aerial vehicle, or any other type of moving object, or vice versa. A UAV may be capable of traversing an environment. The UAV may be capable of flight within three dimensions. The UAV may be capable of spatial translation along one, two, or three axes. The one, two or three axes may be orthogonal to one another. The axes may be along a pitch, yaw, and/or roll axis. The UAV may be capable of rotation about one, two, or three axes. The one, two, or three axes may be orthogonal to one another. The axes may be a pitch, yaw, and/or roll axis. The UAV may be capable of movement along up to 6 degrees of freedom. The UAV may include one, two or more propulsion units that may aid the UAV in movement. The propulsion units may be configured to generate lift for the UAV. The propulsion units may include rotors. The moving object may be a multi-rotor UAV.

The UAV may have any physical configuration. For instance, the UAV may have a central body with one or arms or branches extending from the central body. The arms may extend laterally or radially from the central body. The arms may be movable relative to the central body or may be stationary relative to the central body. The arms may support one or more propulsion units. For instance, each arm may support one, two or more propulsion units.

The UAV may have a housing. The housing may be formed from a single integral piece, two integral pieces, or multiple pieces. The housing may include a cavity within where one or more components are disposed. The components may be electrical components, such as a flight controller, one or more processors, one or more memory storage units, one or more sensors (e.g., one or more inertial sensors or any other type of sensor described elsewhere herein), one or more navigational units (e.g., a global positioning system (GPS) unit), one or more communication units, or any other type of component.

The one or more sensors may include one or more types of sensors. Some examples of types of sensors may include location sensors (e.g., global positioning system (GPS) sensors, mobile device transmitters enabling location triangulation), vision sensors (e.g., imaging devices capable of detecting visible, infrared, or ultraviolet light, such as cameras), proximity or range sensors (e.g., ultrasonic sensors, lidar, time-of-flight or depth cameras), inertial sensors (e.g., accelerometers, gyroscopes, and/or gravity detection sensors, which may form inertial measurement units (IMUs)), altitude sensors, attitude sensors (e.g., compasses), pressure sensors (e.g., barometers), temperature sensors, humidity sensors, vibration sensors, audio sensors (e.g., microphones), and/or field sensors (e.g., magnetometers, electromagnetic sensors, radio sensors). The housing may have a single cavity or multiple cavities. In some instances, a flight controller may in communication with one or more propulsion units and/or may control operation of the one or more propulsion units. The flight controller may communicate and/or control operation of the one or more propulsion units with aid of one or more electronic speed control (ESC) modules. The flight controller may communicate with the ESC modules to control operation of the propulsion units.

The one or more communication units may be any type of communication unit. The communication units may be capable of receiving and/or transmitting wireless signals. The communication units may be capable of receiving wireless signals directly from the object of interest, or through a network. The communication units may be capable of receiving signals from a server that may receive information from the object of interest, or through a network (e.g., cloud computing infrastructure) that may receive information from the object of interest. In some embodiments, one-way communications may be provided from the object of interest to the UAV, or vice versa. Otherwise, two-way communications may be provided.

In some embodiments, the UAV may be configured to support a payload using a carrier. The payload may include one or more imaging devices. The carrier may permit the payload to move relative to the UAV. For instance, the carrier may permit the payload to rotate about one, two, three or more rotational axes. In another instance, the carrier may permit the payload to move linearly along one, two, three, or more axes. The axes for the rotational or translational movement may or may not be orthogonal to each other. The relative movement can be a translation with respect to one or more degrees of freedom (e.g., along one, two, or three axes) and/or a rotation with respect to one or more degrees of freedom (e.g., about one, two, or three axes), or any suitable combination thereof. The one, two, or three axes may be any combination of a pitch axis, yaw axis, or a roll axis. The carrier may include a one-axis gimbal, two-axis gimbal, or three-axis gimbal.

The UAV may be capable of manually-controlled flight, semi-autonomous flight, or autonomous flight. In some embodiments, one or more autonomous actions of the UAV may supersede manually controlled flight, or previously instructions for semi-autonomous or autonomous flight. For example, a UAV may be forced to remain outside of a flight-restriction zone. The UAV may be forced to take action when approaching a flight restriction zone, or when close to a flight-restriction zone. For example, the UAV may be forced to alter the UAV's path to remain outside the flight-restriction zone. The UAV may be forced to maintain at least a flight-restriction distance away from an object of interest. The UAV may fly at a flight-restriction distance, or any distance greater than the flight-restriction distance, away from the object of interest. A UAV may not be permitted to fly within a flight-restriction distance of an object of interest. If the UAV is within the flight-restriction distance of the object of interest, the UAV may be forced to land, hover, or increase the UAV's distance until the UAV is at least as far away from the object of interest as the flight-restriction distance. If the UAV is on the ground within the flight-restriction distance of the object of interest, the UAV may be prevented from taking off. If the object of interest moves away so that the UAV is subsequently further than the flight-restriction distance from the object of interest, the UAV may then be allowed to take off. Such autonomous flight responses are provided by way of example only, and additional flight responses by the UAV may be possible.

The UAV may be prevented from entering the flight-restriction region by being forced to maintain at least a certain flight-restriction distance d₁, d₂ away from the object of interest. The flight-restriction distance may depend on a characteristic of the object of interest (e.g., object classification, object movement, timing for the object of interest to process and/or transmit information), a characteristic of the UAV (e.g., UAV classification, UAV movement, UAV physical specifications, timing for the UAV to process received information, timing for the UAV to respond), a characteristic of communications between the UAV and the object of interest (e.g., timing for information to be transmitted from the object of interest to the UAV), and/or any other situational characteristics (e.g., environmental conditions such as weather).

For example, a first UAV 100 may be required to maintain at least a distance d₁ from the object of interest 102. A second UAV 104 may be required to maintain at least a distance d₂ from the object of interest 102. The distances d₁, d₂ may be the same or may be different from one another. The distances may differ depending on a characteristic of the UAV. For example, the first UAV may have a slower flight controller than the second UAV, and may be required to keep a greater distance away from the object of interest than the second UAV.

In another example, the flight-restriction region around the object of interest need to be a circle. For instance, when approaching from a first direction, a UAV 100 may be required to maintain at least a distance d₁ from the object of interest. When approaching from a second direction, the UAV 104 may be required to maintain at least a distance d₂ from the object of interest. Thus, depending on circumstances, for the same object of interest-UAV pair, the flight-restriction distances may differ. Alternatively, they may be the same. When considering the flight-restriction distance around the UAV in all directions (e.g., 360 degrees around the UAV), a flight-restriction region may be defined by the flight-restriction distances around the UAV. The flight-restriction distances around the UAV may define a boundary of the flight-restriction region. In some embodiments, the flight-restriction distances may be determined in a lateral direction. The flight-restriction distances may be determined in a vertical direction and/or a combination of lateral and/or vertical direction. The flight-restriction distances around the UAV in lateral and/or vertical directions may define a flight-restriction space. Any description herein of a flight-restriction region may apply to a three-dimensional flight-restriction space.

The flight-restriction distance may change over time. In some embodiments, the flight-restriction distance may be updated periodically (e.g., at least as frequently as every few minutes, every minute, every few seconds, every second, every few tenths of a second, every tenth of a second, every hundredth of a second, every milliseconds), continuously in real-time, and/or in response to one or more events. Examples of one or more events may include, but are not limited to, detected action by a UAV, a request by a UAV, a detected action by the object of interest, a request by the object of interest, a request from a third party device (e.g., server, remote controller), or an event associated with a communication system. Alternatively, the flight-restriction distance may remain the same and not change over time.

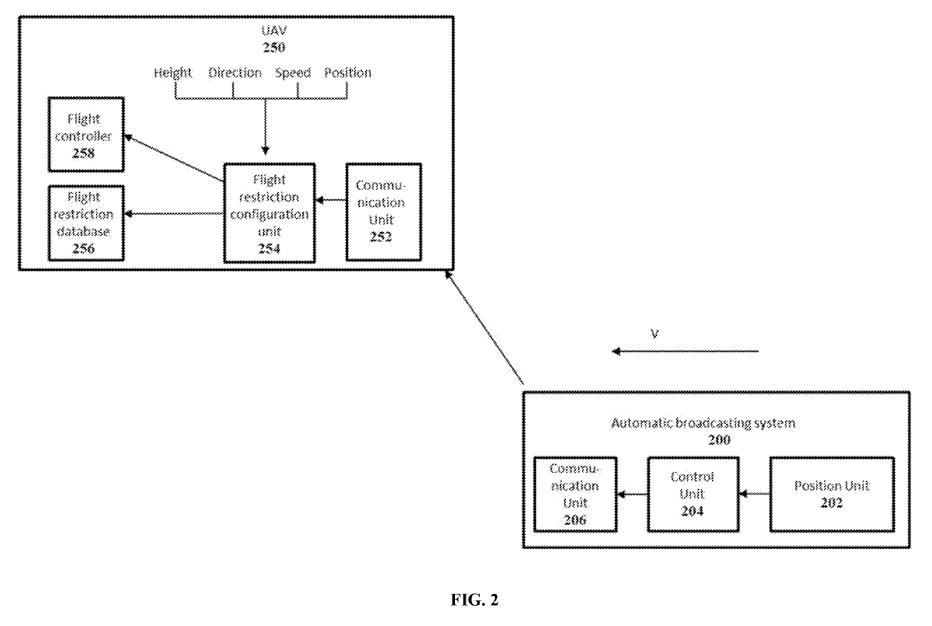

An example of a flight restriction environment is shown in FIG. 2. The flight-restriction environment may comprise an automatic broadcasting system 200 and a UAV 250. The automatic broadcasting system may comprise a location unit 202, a control unit 204, and/or a communication unit 206. The UAV may comprise a communication unit 252, a flight-restriction configuration unit 254, and/or a flight-restriction database 256.

As previously described, an object of interest may comprise a beacon, may be physically or operably coupled to the beacon, or may be the beacon itself. The beacon may be an automatic broadcasting system 200. The beacon may broadcast information widely and wirelessly. The beacon may broadcast information so that it may be received by untargeted recipients of any type that may be capable of detecting information broadcast in a particular manner (e.g., particular frequency). Alternatively, the beacon may transmit information in a targeted manner so that only intended recipients may receive the information. The information may or may not be encrypted. Any description herein of an automatic broadcasting system may apply to any type of beacon or object of interest that may transmit information.

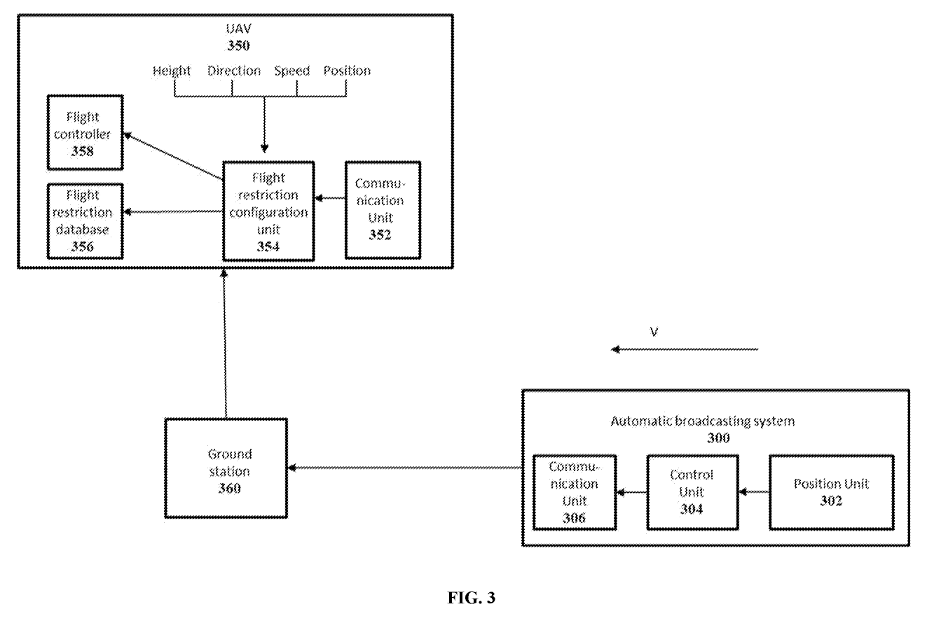

In one embodiment, a flight-restriction environment may be provided by a commercial airline, the commercial airliner providing one or more signals (e.g., data) which can be pushed to the UAV as necessary. The data may be pushed continuously or only when the UAV is within a certain range of the automatic broadcasting system (e.g., on the commercial airline) for security purposes. When data is pushed to the UAV, the UAV may execute one or more appropriate flight control responses as necessary (e.g., stop moving forward or land). An example of this type of flight restriction environment is shown in FIG. 3.

FIG. 3 illustrates a flight-restriction environment similar to that of FIG. 2, except for an additional ground station 360. The commercial airliner may establish a communication link with the ground station and send signal data to the ground station. The ground station 360 may in turn push data to the UAV if predetermined condition is satisfied (e.g., the UAV is in range of the ground station). All other components of FIG. 3 (e.g., automatic broadcasting station 300, position unit 302, control unit 304, communication unit 306, UAV 350, communication unit 352, flight-restriction configuration unit 354, flight-restriction database 356, and flight controller 358) may perform functions in the same manner as their respective counterparts in FIG. 2 (e.g., automatic broadcasting station 200, position unit 202, control unit 204, communication unit 206, UAV 250, communication unit 252, flight-restriction configuration unit 254, flight-restriction database 256, and flight controller 258, respectively).

One or more objects of interest may be configured with an automatic broadcasting system 200, which may broadcast information. The information may comprise one or more parameters of the object of interest. Parameters of the object of interest may include, but are not limited to, a unique identity of the object of interest, an object type or classification, one or more physical characteristics of the object of interest, such as whether the object of interest is capable of motion, types of movements and/or speeds that the object of interest is capable of, or any specialized status of an individual associated with the object of interest or with the object of interest itself. The information can comprise location and/or movement information of the object of interest. The information of the object of interest may be provided on a periodic basis, in real-time, and/or in response to an event. The location and/or movement information may reflect the most up-to-date information about the object of interest. The location and/or movement information may reflect information within a predetermined period of time. The predetermined period of time may be a time period most recent (e.g., closest in time) to a moment at which a flight-restriction distance is being calculated. The location and/or movement information may comprise the last known location, velocity, direction, direction of velocity vector, acceleration, direction of acceleration vector received from an object of interest within the predetermined period of time. The location and/or movement information may include, but is not limited to, latitude, longitude, altitude, orientation with respect to a pitch, yaw, or roll axis, linear speed, angular speed, linear acceleration, angular acceleration, direction, time, or other information. The location and/or movement information may be determined with aid of a location unit 202. The location unit may comprise a global positioning system (GPS) unit that may determine geospatial coordinates of the object of interest. The positioning unit may comprise one or more inertial sensors, such as one or more accelerometers, gyroscopes, magnetometers, or any other type of sensor that may aid in detecting motion of the object of interest (e.g., linear and/or angular motion). The location unit may utilize images, infrared signals, radio signals, and/or any other type of information in providing location and/or movement information of the object of interest. The location unit may receive information from outside the object of interest (e.g., satellites, external sensors), and/or information that is self-contained to the object of interest (e.g., from inertial sensors).

The location unit may perform functions of receiving or measuring data (e.g., information about the associated object of interest). The location unit may comprise a receiving module and/or a measurement module. The data receiving module may receive an external signal (e.g., from a GPS receiver, a communication network receiving module (e.g., SIM card), a satellite data receiving module) in real-time. The measurement module may measure one or more parameters of the object of interest (e.g., accelerometer, gyroscope, compass, barometer, pitot/speed meter). Different parameters may be measured and received for different objects of interest; hence, the data receiving and measuring module can be automatically or manually adjusted based on a type of the object of interest.

For UAVs, the necessary information may be provided from an automatic broadcasting system 200 (e.g., an automatic dependent surveillance-broadcast (ADS-B) system). The information (e.g., position or altitude information) of objects of interest acquired by the object of interest's location unit may be manually or automatically set. For instance information from a stationary object can be manually set, such that some or all of the information sent from the object of interest's communication unit 206 may be a set of statically defined values (e.g., spatial coordinates). The manual setting may be performed by a user of the object of interest (e.g., a building manager). For instance information from a moving object can be automatically set, such that some or all of the information sent from the object of interest's communication unit 206 may be acquired from one or more sensors. For example, the position or altitude information of moving objects can be received from a GNSS system (such as GPS, BeiDou system, Glonass, Galileo), a mobile communication network, a low-altitude radar, etc. The object of interest information may then be passed to the object of interest's control unit 204 and broadcast by the object of interest's communication unit 206 to the UAV's communication unit 252 through a communication channel.

The control unit 204 may receive information from the location unit 202. After data is collected at the location unit, the control unit may decide which of the information will be broadcast. The control unit may comprise one or more processors that may individually or collectively make the determination. The control unit may receive a portion or all of the information acquired by the location unit. The control unit may receive information from the location unit at regularly scheduled time intervals (e.g., 100 milliseconds (ms), one second (s), 10 s, one minute (min), 10 min, 30 min, one hour (hr), several hr, 12 hr, 24 hr, or several days).

The control unit 204 may receive information from the location unit 202 corresponding to a set of one or more sensors. For each sensor in the set, such information may be collected at the same time or at different times. For instance location data may be transmitted at longer time intervals from sensors that need a relatively long time to acquire data (e.g., from a GNSS network) compared to sensors that need a relatively short time to acquire data (e.g., an accelerometer on-board the UAV). The time intervals may be adjusted based on a type of the object of interest or a parameter of the object of interest. For instance time intervals may be shorter (e.g., more frequent communication of data) for a moving object than a stationary object. For instance time intervals may be shorter for a moving object of a type with a faster maximum speed (e.g., an airplane, a train, or a car) than a moving object of a type with a slower maximum speed (e.g., a UAV or a bicycle). For instance time intervals may be shorter for a fast moving object than a slow moving object. For instance time intervals may be shorter for a moving object at higher altitude than a moving object at a lower altitude. In general, shorter time intervals may enable more frequent communication of data, which may be appropriate in cases where greater protection from the chance of collision between the UAV and the object of interest may be desired.

The control unit 204 can perform data fusion and calculation on sensor data as received or parameters, in order to obtain the one or more parameters to be broadcast. For instance location data could be directly acquired (e.g., from a GNSS such as GPS) or indirectly calculated on sensor data by the control unit (e.g., using location data from a previous time point and velocity and/or accelerometer data). This approach could conserve power consumption rate by using increased time intervals for some types of information or parameters that may be power-intensive (e.g., GNSS) to perform each data acquisition compared to other types of information or parameters that may be less power-intensive to acquire (e.g. data from an accelerometer or a compass). Alternatively, this approach could conserve power consumption rate by using increased time intervals for some types of information or parameters that may be slow to acquire compared to other types of information or parameters that may be faster to acquire. Sensor data may be associated with the location of the object of interest at a time point, and may comprise latitude, longitude, altitude, speed, or direction. Sensor data or parameters may be received from one or more of: a global navigation satellite system (GNSS), a mobile communication network, a low-altitude radar system, an altimeter, or a barometer. In an embodiment, the GNSS comprises a global positioning system (GPS), a BeiDou navigation satellite system, a GLONASS navigation satellite system, or a Galileo navigation satellite system.

The automatic broadcasting system may comprise a communication unit 206. The communication unit may transmit the information from the control unit 204. The information may be transmitted wirelessly. The communication unit may be configured for one-way communication from the automatic broadcasting system, and may be capable of transmitting information. Communication unit may be configured for two-way communication, and may be capable of both transmitting and receiving information.

The information may be transmitted directly to the UAV 250. The information may be received directly by the UAV without going through any intermediary device. In some embodiments, Bluetooth, infrared, WiFi, or other types of signals may be used to transmit the information. The information may be transmitted indirectly to the UAV. The information may be received indirectly by the UAV by going through one or more intermediary devices. Examples of other intermediary device may include, but are not limited to, routers, communication towers, satellites, other objects, other UAVs, servers, and/or any other types of devices. Indirect communications may comprise communications over wide area networks (WAN) such as the Internet, local area networks (LAN), or telecommunications networks, such as 3G, 4G, or LTE communications.

The UAV 250 may receive and process the information from the automatic broadcasting system 200, and determine a flight-restriction region and/or distance for the object of interest based on the all or a subset of the information. The flight-restriction region and/or distance may be determined based on information about the UAV itself. The flight-restriction region and/or distance may be determined based on information about the communication between the automatic broadcasting system and the UAV. The flight-restriction region and/or distance information may depend on timing components as discussed in greater detail elsewhere herein.

The UAV may comprise a communication unit 252 that may receive the information from the automatic broadcasting system. The communication unit may be configured for one-way communication for receiving information, and may be capable of receiving information from the automatic broadcasting system. The communication unit may be configured for two-way communication, and may be capable of both transmitting and receiving information.

The UAV may comprise a flight-restriction configuration unit 254. The flight-restriction configuration unit may be on-board the UAV and/or off-board the UAV (e.g., on a remote control communicatively linked to the UAV). The flight-restriction configuration unit may comprise one or more processors that may individually or collectively aid in determining a flight-restriction region and/or distance for the object of interest. The flight-restriction configuration unit may use at least some of the information received from the communication unit 252 in determining a flight-restriction region and/or distance.

The flight-restriction configuration unit may include information about the UAV in making the determination. For example, the information about the UAV may include a characteristic of the UAV, such as UAV classification, UAV movement, UAV physical specifications, timing for the UAV to process received information, timing for the UAV to respond. A UAV classification may refer to a type of UAV, such as a make or model of the UAV. The brand of UAV may be considered. The UAV classification make take into account a design of the UAV, a propulsion system of the UAV, size of the UAV, navigation system of the UAV, communication of the UAV. The UAV classification may be selected from a plurality of available UAV classifications. UAV movement may include UAV speed, direction, rotation, acceleration, and/or location. The UAV movement may take into account a projected trajectory of the UAV. The UAV movement may take into account past movement by the UAV during the current flight session of the UAV or previous flight sessions. UAV physical specifications may include maneuverability of the UAV, braking speed of the UAV, turning radius of the UAV, or other physical specifications of the UAV. Timing for the UAV to process information may depend on processing speed of one or more processors on-board the UAV. The speed at which a flight controller and/or flight-restriction configuration unit may operate may affect the timing for the UAV to process information. The communication unit of the UAV may also affect the timing for the UAV to process information. The timing for the UAV to respond may depend on the timing for the UAV to process received information and/or UAV physical specifications.

A flight-restriction region can be a two-dimensional (2-D) flight-restriction region (or flight-restriction area), or a three-dimensional (3-D) flight-restriction region (or flight-restriction volume). A 2-D flight-restriction region (or flight-restriction area) may be determined based on latitude and longitude information about the object of interest. For example, coordinates, such as latitude and longitude coordinates may be used. A 3-D flight-restriction region (or flight restriction volume) may be determined based on latitude, longitude, and altitude information of the object of interest. For example, spatial coordinates, such as latitude, longitude, and altitude coordinates may be used. Parameter measurements may differ for different operation modes or status of a UAV.

The flight-restriction configuration unit may also make a determination as to the type of flight-response by a UAV 250 in one or more scenarios. The flight-restriction configuration unit may specify one or more types of flight-response by the UAV when the UAV is approaching or within a flight-restriction distance. The type of flight response may depend on the circumstances of the UAV and/or the object of interest. Further examples are provided in greater detail elsewhere herein.

The flight-restriction configuration unit may be on-board the UAV 250. In alternative embodiments, one or more of the functions of the flight-restriction configuration units may be performed off-board the UAV. For example, one or more of the functions of the flight-restriction configuration units may be performed at a device (e.g., server, remote controller) remote to the UAV and/or the object of interest. The device may receive information from the automated broadcasting system and/or the UAV to perform the functions. In another example, one or more of the functions of the flight-restriction configuration units may be performed using a network (e.g., cloud computing infrastructure). Information from the automated broadcasting system and/or the UAV may be provided to the network (e.g., cloud) to perform the functions. In an additional example, one or more functions of the flight-restriction configuration units may be performed on-board the object of interest. Information may be provided from the UAV to allow the object of interest to perform the functions. Any device that performs one or more functions of the flight-restriction configuration units may send information to the UAV.

The UAV may comprise a flight controller 258. The flight controller 258 may generate one or more signals that may control one or more propulsion units of the UAV. The flight controller may comprise one or more processors that may individually or collectively generate the signals that may be used to control the one or more propulsion units. The flight controller 258 may generate the signals based on information generated by the flight-restriction configuration unit. The flight controller 258 and the flight-restriction configuration unit may or may not share one or more processors.

The UAV 250 may comprise a flight-restriction database 256. The flight-restriction database may comprise one or more memory storage units that may store flight-restriction information. The memory storage units may allow for local storage of flight-restriction data on the UAV. There may be several benefits of this approach. Flight-restriction data may be quickly and easily accessible as needed by the UAV (e.g., upon request by the UAV's user). The UAV will be less affected by communication delay with external objects. Historical flight-restriction data may be stored on the memory storage units such that the UAV can refer back to flight-restriction data from previous time points (e.g., under different UAV operating conditions).

The flight-restriction data in a flight restriction database 256 may be updated directly by the flight-restriction configuration unit 254. The flight-restriction configuration unit 254 may have received that data from the communication unit 252. The communication unit 252 may have received that data from an object of interest's automatic broadcasting system 200. The flight-restriction data may be associated with flight-restriction regions corresponding to stationary objects (e.g., static flight-restriction regions) and/or moving objects (e.g., moving flight-restriction regions).

The flight-restriction data may be updated by communication with a network (e.g., cloud). Such a cloud network (or another type of network) may comprise flight-restriction data from other UAVs. The information of static flight-restriction regions may be stored in a cloud network (or another type of network). The information of a portion or all of the moving flight-restriction regions may be stored in a network. The UAV can receive the data from the network through a wireless communication protocol (e.g., LTE, SMS, Bluetooth, WiFi) or a wired communication protocol (e.g., USB, USB2, USB3, FireWire). A network may comprise flight-restriction data associated with one or more distinct jurisdictions (e.g., local, national, or international). A UAV's flight restriction database may be updated with flight-restriction data from the network when the UAV moves from one jurisdiction to another (e.g., to be updated with the most recent set of flight-restriction rules associated with the jurisdiction under which the UAV is operating at a current time). Updates of flight-restriction data may be pulled from a network by a UAV in response to certain detected events (e.g., moving across jurisdictions) or according during regularly scheduled intervals (e.g., a daily, weekly, monthly, or annual update). Updates of flight-restriction data may be pushed to a UAV by a network.

Flight-restriction data in a flight-restriction database 256 may comprise a short-term map or a long-term map. A short-term map may include flight-restriction information (e.g., real-time information) associated with presently detected objects of interest (e.g., on the order of the most recent few minutes to several hours). Alternatively, a short-term map may include flight-restriction information associated with objects of interest within a certain range of the UAV. For instance for security reasons, if the object of interest is Air Force One carrying the president, the object of interest may only broadcast flight-restriction information if the UAV is within a certain range. A long-term map may include flight-restriction information associated with stationary objects or features (e.g., known buildings such as airport locations, public domain information, etc.).

The flight-restriction database 256 may comprise a set of coordinates (e.g., latitude, longitude, and/or altitude) associated with one or more objects of interest. These objects of interest may comprise those associated with a short-term map (e.g., presently detected objects of interest in proximity) or those associated with a long-term map (e.g., stationary objects or features that are either configured to communicate with a UAV or having a known spatial location). The flight-restriction database 256 may comprise a set of minimum flight-restriction distances (e.g., lateral distance, vertical distance, or true distance) associated with one or more objects of interest. This set of minimum flight-restriction distances could be updated depending on circumstances (e.g. moving across jurisdictions) or timing (e.g. during regularly scheduled intervals). The flight-restriction database 256 may comprise a set of times associated with these flight-restriction distances (e.g., a set of flight-restriction rules that only apply during airport operation hours or business hours of a building). The flight-restriction database 256 may comprise a set of flight responses associated with an operating state (e.g., comprising one or more parameters of the UAV, local environmental conditions, time of day). A flight response may be provided by the flight restriction configuration unit 254, by the communication unit 252 of the UAV, or by the automatic broadcasting system 200 of an object of interest.

The object of interest may be a moving or stationary object. For example, as illustrated in FIG. 3, the object of interest may be moving at a velocity v. The automated broadcasting system may be moving in the same manner as the object of interest, or may be the object of interest itself. The UAV may be required to maintain at least a flight-restriction distance away from the object of interest. The flight-restriction distance may change as the object of interest and/or UAV moves, or may remain substantially the same. The flight-restriction distance may change over time, or may remain substantially the same.

A flight-restriction region may be a static region corresponding to a stationary object. The flight-restriction region may be a 2-D or 3-D flight-restriction region. A UAV may compare its own location relative to the flight-restriction region. Based on the flight-restriction distance and a distance between the UAV and the object of interest, the UAV may perform a flight response. In some embodiments, the UAV may compare its own geo-spatial coordinates with geo-spatial coordinates of the object of interest to calculate the distance between the UAV and the object of interest and/or determine whether the UAV is within a flight-restriction distance. This information may be used to make an assessment of whether the UAV is to take a flight response measure.

For example, a 3-D flight-restriction region may be defined based on GPS coordinates and height of a stationary object (e.g., a non-moving object with a range of motion of substantially zero in latitude, longitude, and altitude). The UAV may compare its own GPS coordinates with the information of the flight-restriction region, and may execute a flight response based on the distance between the UAV and the object of interest. For example, a UAV's flight response may comprise performing a braking operation if it is detected that the UAV is approaching the object of interest. In another example, the UAV's flight response may be to continue flying but veer away from the flight-restriction region. In another example, the UAV's flight response may be to change its speed (e.g., accelerate or decelerate). In another example, the UAV's flight response may be to change its altitude (e.g., fly higher or lower than its current position). In another example, the UAV's flight response may be to change its direction (e.g., make a left turn or a right turn by a certain number of degrees). In another example, the UAV's flight response may be to land (e.g., immediately or to return to a predetermined location). The three-dimensional flight-restriction region may be characterized by restrictions in ranges corresponding to one or more of latitude, longitude, and/or altitude. For example, a UAV may be instructed to maintain at least a flight-restriction region of 10 meters away from a building in all lateral directions, but can fly over the building from its roof. The restrictions in any of the directions (e.g., latitude, longitude, altitude) may be the same or may be different.

A UAV may take a flight response measure when the UAV is approaching or within a flight-restriction region of an object of interest. It may be determined that the UAV is within a flight-restriction region when the UAV is within a flight-restriction distance of the object of interest. Examples of flight response measure may include, but are not limited to, being prevented from taking off from a landed state, being forced to land immediately, being forced to land after a set period of time, being forced to decrease altitude, being forced to increase altitude to a predetermined altitude, hovering, braking, changing flight direction, being forced to auto-return to a pre-set location. In some embodiments, in addition or as an alternative to taking the flight response measure, a user of the UAV may receive a warning. The warning may be indicative of an operational status of the UAV and/or the types of flight-response measures that may be instituted if the user does not avoid the flight-restriction region.

In some embodiments, the flight response measure may be determined based on an operational status of the UAV. Examples of operational status of the UAV may include, the UAV being powered on or powered off, the UAV being in flight or being in a landed state, the UAV being within or outside a flight-restriction region, or the UAV having a projected trajectory that does intersect or does not intersect a flight-restriction region.

Table 1 illustrates examples of how different flight response measures could be used in response to different examples of operation status of a UAV to generate an appropriate response and/or a warning to the pilot (user) of the UAV.

TABLE 1

| Operation status of a UAV | Operation Steps | Warning |
|---|---|---|
| Before taking off, UAV | Taking off is prohibited, or | The pilot (user) of UAV |
| receives broadcast | a height of flight is limited | received warning via UAV |
| information and is within | | data link |
| flight restriction regions | | |
| During flight, UAV | Auto-return, or fast | The pilot (user) of UAV |
| receives broadcast | ascending, or exiting flight | received warning via UAV |
| information and is within | restriction region by lowest | data link |
| flight restriction regions | estimate, or landing at it is | |
| | can be triggered | |
| During flight, UAV | Flight of UAV can be | The pilot (user) of UAV |
| receives broadcast | regulated as designed | received warning via UAV |
| information and is not | | data link |
| within flight restriction regions | | |

A flight-restriction distance may be determined for the UAV to maintain relative to an object of interest. The flight-restriction distance may determine a portion of a boundary of a flight-restriction region. If a UAV if within a flight-restriction distance relative to the object of interest for a particular moment in time, the UAV may be within the associated flight-restriction region for that moment in time.

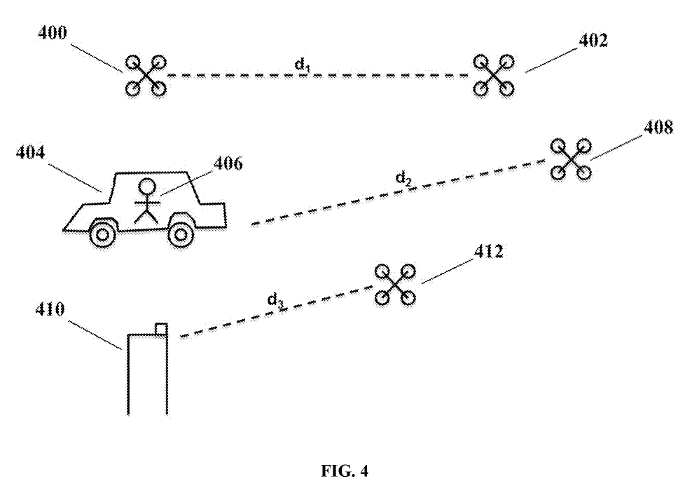

In some embodiments, a flight-restriction distance may depend on one or more physical characteristics of the object of interest (e.g., speed). For instance the object of interest may be a stationary object or a moving object. In some embodiments, the flight-restriction distance may depend on how quickly the object of interest is moving. For example, it may be desirable to have a greater flight-restriction distance relative to an object of interest that is moving, in case the object of interest moves in a way that may bring about a collision. For example, as shown in FIG. 4, when an object of interest is another UAV 400, a UAV 402 may have a flight-restriction distance of at least d₁. When an object of interest is a land-bound vehicle 404, a UAV may have a flight-restriction distance of at least d₂. The UAV may be capable of moving more quickly than the land-bound vehicle, which may mean d₁>d₂. When an object of interest is a stationary object, such as a beacon on a building 410, a UAV may have a flight-restriction distance of at least d₃. Since the building is not moving at all, d₁>d₃, and/or d₂>d₃.

In some implementations, the flight-restriction distance may depend on the characteristics of how the object of interest is moving. For example, objects of interest that may have a more erratic characteristic movement, or a greater degree of freedom of motion, may have a greater flight-restriction distance, relative to an object of interest that is a more stable or predictable type of movement, or more restricted types of movement. For example, a UAV 400 may have a greater degree of motion in its flight, or a more unpredictable type of flight path, compared to a land-bound vehicle 404 that may be confined to moving on the ground, and/or along a road. A greater flight-restriction distance may be provided when the object of interest is the UAV, rather than when the object of interest is a land-bound vehicle.

The flight-restriction distance may depend on a direction that the object of interest is moving relative to the UAV. For instance if the object of interest is moving toward the UAV, a greater flight-restriction distance may be provided compared to if the object of interest is moving away from the UAV. This greater flight-restriction distance accounts for the time needed for the UAV to brake (e.g., reduce speed), land (e.g., reduce speed to zero), or change its flight path relative to the object of interest (e.g., to take evasive action to avoid a collision with the object of interest). If the object of interest is moving away the UAV, a smaller flight-restriction distance may be provided, since the UAV is less likely to be required to brake (e.g., reduce speed), land (e.g., reduce speed to zero), or change its flight path relative to the object of interest (e.g., to take evasive action to avoid a collision with the object of interest).

The flight-restriction distance may depend on a classification or priority of an object of interest and/or an associated person 406. For instance if the object of interest is very important for safety (e.g., an airport) or political reasons (e.g., a government building), a greater flight-restriction distance may be provided compared to if the object of interest is less important (e.g., an office building or a private citizen's home). This greater flight-restriction distance accounts for the time needed for the UAV to brake (e.g., reduce speed), land (e.g., reduce speed to zero), or change its flight path relative to the object of interest (e.g., to take evasive action to avoid a collision with the object of interest).

The flight-restriction distance may depend on how quickly information about the object of interest is collected, processed, and transmitted. For instance if this information takes a significant amount of time relative to the speed of the object of interest (e.g., the object of interest has a high speed relative to the speed of the UAV, such as an aircraft, a train, or a car) or the speed of the UAV (e.g., the UAV is moving at a high speed), a greater flight-restriction distance may be provided compared to if this information takes an insignificant amount of time relative to the speed of the object of interest (e.g., the object of interest does not have a high speed relative to the speed of the UAV, such as a stationary object) or the speed of the UAV (e.g., the UAV is moving at a low speed).

In some embodiments, the flight-restriction distance may depend on one or more characteristics of the UAV (e.g., maximum speed, size, maneuverability, cost for the UAV to take a flight response measure, classification or priority of the UAV, the rate at which information is communicated between the UAV and the object of interest, or the rate at which information is processed at the UAV).

The flight-restriction distance may depend on the maximum speed of the UAV. For instance if the UAV has a high maximum speed, a greater flight-restriction distance may be provided compared to if the UAV has a low maximum speed. This approach assures greater protection in the event of malfunction of the UAV causes unreliable or unpredictable operation.

The flight-restriction distance may depend on the size of the UAV. For instance if the UAV has a large size, a greater flight-restriction distance may be provided compared to if the UAV has a small size. This approach assures greater protection in the event of collision between the UAV and an object of interest, since a heavier UAV is capable of inflicting greater damage and poses greater risk to objects of interest and people.

The flight-restriction distance may depend on the maneuverability of the UAV. For instance if the UAV has a low maneuverability, a greater flight-restriction distance may be provided compared to if the UAV has a high maneuverability. This approach assures greater protection in the event of the sudden appearance of an object of interest or other event which may trigger a flight response for the UAV.

The flight-restriction distance may depend on the cost for the UAV to take a flight response measure. For instance if the UAV is flying at a high altitude or has a low remaining battery capacity, and hence has a high cost to perform a landing response, a greater flight-restriction distance may be provided compared to if the UAV is flying at a low to moderate altitude or has sufficient remaining battery capacity, and hence has a low to moderate cost to perform a landing response. This approach assures greater protection in the event of a sudden appearance of an object of interest or other event which may trigger a flight response for the UAV.

The flight-restriction distance may depend on the classification or priority of the UAV. For instance if the UAV has a high priority, a greater flight-restriction distance may be provided compared to if the UAV has a low priority. This approach assures greater protection for a UAV against collisions because of the valuable nature of the UAV. The UAV may have high priority because of its high value, its valuable payload, and/or its high-priority passengers or associated user.

The flight-restriction distance may depend on the rate at which information is communicated between the UAV and the object of interest. For instance if the communication between the UAV and the object of interest occurs at a low rate, a greater flight-restriction distance may be provided compared to if the communication between the UAV and the object of interest occurs at a high rate. This approach assures greater protection for a UAV which may have slow communication with the object of interest and hence may need more time to determine a course of action during operation.

The flight-restriction distance may depend on the rate at which information is processed at the UAV. For instance if the UAV processes information at a low rate, a greater flight-restriction distance may be provided compared to if the UAV processes information at a high rate. This approach assures greater protection for a UAV which may have slow performance and hence may need more time to determine a course of action during operation.

The flight-restriction distance may depend on the communication time for the UAV to communicate with the object of interest. For instance if the UAV communicates with the object of interest with a relatively long communication time, a greater flight-restriction distance may be provided compared to if the UAV communicates with the object of interest with a relatively short communication time. For instance a wireless communication link between the UAV and the object of interest may be slow at large distances between the UAV and the object of interest, or if the wireless network experiences network congestion, or if the UAV and the object of interest communicate indirectly through a common network (e.g., a cloud network). The communication time between the UAV and the object of interest may depend on a network latency of a communication network through which information is transmitted. For instance, an amount of time required to transmit information about a location of the object of interest to the UAV may depend on a network latency of the communication network through which the information about the location of the object if interest is transmitted. Network latency may be an expression of the amount of time it may take for a data packet to travel from the object of interest to the UAV or vice versa. Network latency may depend on network congestion, travel path, queuing delay, processing delay, bufferbloat, environmental conditions, signal strength, available bandwidth, or any other factors. This approach assures greater protection for a UAV which may have slow performance and hence may need more time to determine a course of action during operation.

The flight-restriction distance may depend on environmental conditions, e.g. weather. For instance if the UAV is operating in an environment with high wind conditions, a greater flight-restriction distance may be provided due to the possible erratic nature of the UAV's flight. For instance if the UAV is operating in a foggy or similar low-visibility environment, a greater flight-restriction distance may be provided due to the possible unreliable operation of sensors or the possible unreliable detection of the object of interest.

A flight-restriction distance may be generated for a UAV relative to the object of interest. The UAV may keep at a minimum the flight-restriction distance away from the object of interest. In some embodiments, the flight-restriction distance may be generated based on an amount of time for one or more processes that may occur at the object of interest, at the UAV, and/or between the object of interest and/or UAV. The flight-restriction distance may depend on an amount of time for data to be collected and/or processed at the object of interest and/or UAV.

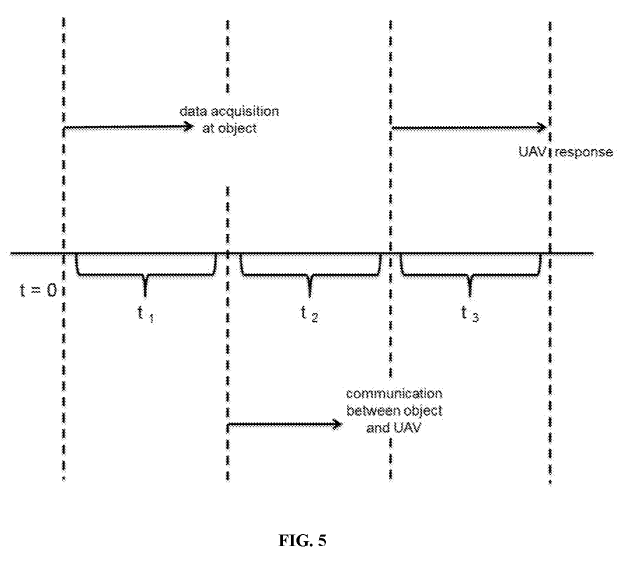

FIG. 5 shows examples of the different timing components related to communication steps (e.g. data acquisition time, communication time, or calculation time) that may involve the object of interest and/or the UAV. Each of these time components may affect a generated flight-restriction distance. The time components may include an amount of time for data acquisition at an object of interest (t₁). The amount of time for data acquisition at an object of interest may include an amount of time to gather information about the object of interest, such as position information about the object of interest. The amount of time for data acquisition information may include an amount of time for a location unit at an automated broadcasting system to perform one or more functions.

The amount of time for data acquisition may also include an amount of time for a control unit at an automated broadcasting system to perform one or more functions. The amount of time for data acquisition may include an amount of time to process information collected by the location unit (e.g., a sum of one or more sensor response times) and/or perform any related calculations or determinations (e.g., to process raw data to correct for possible deviations). The amount of time for data acquisition may include an amount of time to select a subset of the raw or processed data from the location unit to be transmitted to the UAV.

The amount of time for data acquisition may include an amount of time for a communication unit to transmit information to the UAV. The communication unit may comprise a transmitter that may take a certain amount of time to prepare and send data.

The amount of time for data acquisition may depend on processing speed of one or more processors on-board the object of interest. For instance, the processing speed of a location unit and/or control unit may depend on a speed of one or more associated processors. The speed of the processors may depend on a type of the processors, a configuration between two or more processors, power consumption requirements or restrictions of the processors (e.g., to preserve battery draw or to allow UAV operation for at least a predetermined amount of time on a fully charged battery). The amount of time for data acquisition may depend on a type of sensor, or the specific sensors used to aid in the collection of location data. In some embodiments, environmental conditions or circumstances may affect the functioning of a sensor. For example, a sensor may comprise a GPS sensor. If there is interference from surrounding structures or due to weather conditions, it may take a longer amount of time for the GPS sensor to collect the coordinates. For example, a sensor may comprise an altimeter. If there is interference from surrounding structures or due to weather conditions, it may take a longer amount of time for the altimeter sensor to collect the altitude location data.

In some embodiments, the amount of time for data acquisition may be on the order of minutes, a single minute, seconds, a single second, tenths of a second, hundredths of a second, milliseconds, or nanoseconds.

The timing components may include an amount of time for communication between an object of interest and the UAV (t₂). The amount of time for communication may include an amount of time for one or more of the following: for a communication unit (e.g., of the UAV or the object of interest) to initialize a communication channel (e.g., a wireless communication network), for a communication unit (e.g., of the UAV or the object of interest) to initialize a communication channel with a cloud network, for a communication unit (e.g., of the object of interest) to send one or more pieces of information to the UAV, for a communication unit (e.g., of the object of interest) to terminate a communication channel, or for a communication unit (e.g., of the UAV or the object of interest) to re-establish a communication channel in the event of a disruption in communication (e.g. power failure of the UAV or the object of interest, environmental conditions such as inclement weather, an error in normal UAV operation, an error in normal object operation, or a user error).

The timing components may include an amount of time for a UAV response (t₃). An amount of time for a UAV response may include an amount of time for a communication unit of the UAV to receive and convey information from the object of interest.

The amount of time for the UAV response (t₃) may include an amount of time for a UAV to calculate a flight-restriction distance and/or flight-restriction region. The amount of time for the UAV to perform such calculations may be determined based on previous amounts of times where the UAV has performed such calculations. The amount of time for the UAV to perform such calculations may be an estimated time for the UAV to perform such calculations based on one or more parameters of one or more components of the UAV. For instance the amount of time for the UAV to perform such calculations may be increased at extreme temperatures (e.g., at a high end or low end of the operating temperature range of the UAV) due to instability of processors, communication, network, or other similar components.

The amount of time for the UAV response (t₃) may include a predicted amount of time for a UAV to complete a flight response measure. This flight response measure may comprise braking (e.g., reducing speed), accelerating (e.g., increasing speed), altering direction (e.g., to maneuver around an object of interest or obstacle), or landing (e.g., reducing speed to zero). For instance the amount of time for the UAV to perform a braking operation may depend on the initial speed before braking and desired final speed after braking. For instance the amount of time for the UAV to land may depend on the initial speed before landing and the distance between the UAV and the desired landing location. The flight response time may depend on the specifications of the UAV (e.g., maneuverability). The flight response time may depend on environmental conditions (e.g., may be larger for inclement weather conditions such as high wind or foggy or other low-visibility conditions).

The timing components may include a weighted sum of two or more of the amount of time for data acquisition at an object of interest, the amount of time for communication between the object of interest and the UAV, and/or the amount of time for the UAV response. In some embodiments, the timing components may include a weighted sum where each of these types of amount of time are weighted equally. Alternatively, different weights may be used for one or more of these types of amount of time. For instance weights may be related to a safety factor to account for variability or deviations in an expected type of amount of time (e.g., higher weights for more variable expected types of amount of time).

The amount of time for data acquisition at an object of interest may be determined by a clock, processor, or other timing unit. This timing unit may be on the object of interest, on the UAV, on a cloud network, or on a computer device in communication with the object of interest or UAV (e.g., computer, mobile phone, or satellite). The amount of time for data acquisition may be determined by subtracting the time stamp (e.g., from a timing unit) at which a piece of data is received (e.g., from a sensor) from the time stamp (e.g., from a timing unit) at which a piece of data is requested. The difference in times indicated by the time stamps is the delay due to data acquisition. A timing unit (e.g., on the object of interest or on the UAV) may periodically synchronize its clock with another timing unit (e.g., on a cloud network or on a computer device).

The amount of time for communication between an object of interest and a UAV may be determined by a clock, processor, or other timing unit. This timing unit may be on the object of interest, on the UAV, on a cloud network, or on a computer device in communication with the object of interest or UAV (e.g., computer, mobile phone, or satellite). The amount of time for communication between an object of interest and a UAV may be determined by subtracting the time stamp (e.g., from a timing unit) at which communication was finished from the time stamp (e.g., from a timing unit) at which communication was initiated. The difference in times indicated by the time stamps is the delay due to communication between the object of interest and the UAV. A timing unit (e.g., on the object of interest or on the UAV) may periodically synchronize its clock with another timing unit (e.g., on a cloud network or on a computer device).

The amount of time for a UAV response may be determined by a clock, processor, or other timing unit. This timing unit may be on the UAV, on a cloud network, or on a computer device in communication with the UAV (e.g., computer, mobile phone, or satellite). The amount of time for a UAV response may be determined by subtracting the time stamp (e.g., from a timing unit) at which the UAV finished performing the requested response from the time stamp (e.g., from a timing unit) at which the UAV initiated the response. The difference in times indicated by the time stamps is the delay due to UAV response. A timing unit (e.g., on the UAV) may periodically synchronize its clock with another timing unit (e.g., on a cloud network or on a computer device).

In one example, a flight-restriction distance of a UAV relative to an object of interest can be calculated as:

Lₗᵢₘᵢₜ=L_{safety}+L_{max_deviation_UA}+L_{max_deviation_object}+L_{brake_h}+Lₘᵢₙ (1)

wherein Lₗᵢₘᵢₜ is a flight-restriction distance of a UAV under current flying speed;
L_{max_deviation_UA} is a maximum deviation in the UAV's location data;
L_{max_deviation_object} is a maximum deviation in the stationary object's location data;
L_{safety} is a safety margin;
Lₘᵢₙ is a required minimum distance between the UAV and the object of interest; and
L_{brake_h} is a distance needed to stop the UAV. This object of interest may be a stationary object.

Lₗᵢₘᵢₜ is a flight-restriction distance of a UAV relative to an object of interest, such that the UAV is directed to maintain a separation distance of at least the flight-restriction distance from the object of interest. This separation distance may be a lateral distance, as given by a distance between the UAV's location on the ground and the object of interest's location on the ground. This separation distance may be a true distance, calculated by a distance between the UAV's 3-D spatial coordinate location (e.g., latitude, longitude, and altitude) and the object of interest's 3-D spatial coordinate location (e.g., latitude, longitude, and altitude).

L_{max_deviation_UA} is a maximum deviation in the UAV's location data. This deviation may be calculated as a range of values, measured under typical operating conditions of the UAV, corresponding to a difference between a UAV's measured location data and its true spatial location. This spatial location may be a 2-D spatial coordinate location (e.g., latitude and longitude). This spatial location may be a 3-D spatial coordinate location (e.g., latitude, longitude, and altitude). The maximum deviation in the UAV's location data may be the maximum value of this range of values corresponding to a difference between the UAV's measured location data and its true spatial location.

L_{max_deviation_object} is a maximum deviation in the object of interest's location data. This deviation may be calculated as a range of values, measured under typical operating conditions of the object of interest, corresponding to a difference between an object of interest's measured location data and its true spatial location. This spatial location may be a 2-D spatial coordinate location (e.g., latitude and longitude). This spatial location may be a 3-D spatial coordinate location (e.g., latitude, longitude, and altitude). The maximum deviation in the object of interest's location data may be the maximum value of this range of values corresponding to a difference between the object of interest's measured location data and its true spatial location.

L_{safety} is a safety margin. This safety margin may be zero. This safety margin may be predetermined for the UAV. This safety margin may be calculated based on the UAV's operation mode and/or one or more parameters (e.g., speed). This safety margin may be increased as the UAV's speed increases. This safety margin may be predetermined for the object of interest. This safety margin may be calculated based on one or more parameters of the object of interest (e.g., speed). This safety margin may be increased as the object of interest's speed increases.

Lₘᵢₙ is a required minimum distance between the UAV and the object of interest. This required minimum distance may be zero. This required minimum distance may be a predetermined value set by the UAV. This required minimum distance may be a predetermined value set by the object of interest. This required minimum distance may be a predetermined value set by one or more jurisdictional (e.g., local, national, or international) laws under which the UAV is bound. This required minimum distance may be a predetermined value set by one or more jurisdictional laws (e.g., local, national, or international) under which the object of interest is bound.

L_{brake_h} is a distance needed to stop the UAV. This distance may be zero, e.g., if the UAV is flying away from the object of interest.

Lₗᵢₘᵢₜ may be calculated as a sum of two or more of these factors. Lₗᵢₘᵢₜ may be calculated as a weighted sum of two or more of these factors. A weight of the weighted sum may be a predetermined value. A weight of the weighted sum may be a value determined by a characteristic of the object of interest.

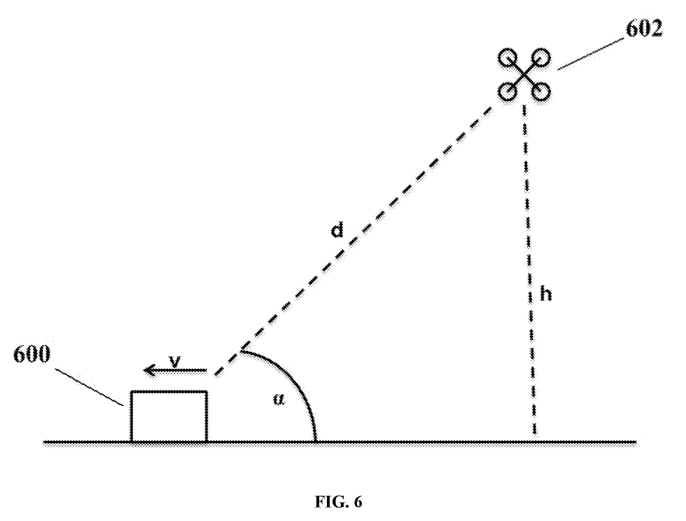

FIG. 6 illustrates a UAV 602 that maintains at least a flight-restriction distance away from an object of interest 600. The object of interest 600 may be a stationary object (e.g. v=0) or a moving object (e.g. v>0). At a given time point, the UAV is located at a true distance d away from the object of interest, at a height of h above the object of interest, at an angle of a between the incidence vector (e.g., directed from the UAV to the object of interest) and the horizontal plane. Given a value of Lₗᵢₘᵢₜ, the UAV's flight operation may be controlled such that the distance of d is maintained at least the value of Lₗᵢₘᵢₜ (e.g., d>Lₗᵢₘᵢₜ). If the object of interest is a moving object, then the values of distance d, angle α, and Lₗᵢₘᵢₜ may be changing over time. This situation may require that the UAV's flight operation be continuously monitored and controlled to maintain the flight-restriction distance.

When a lowest height limit applies to a stationary object, and the UAV is allowed to fly no lower than a height, a vertical distance of a UAV relative to a stationary object can be similarly calculated as:

Hₗᵢₘᵢₜ=H_{safety}+H_{max_deviation_UA}+H_{max_deviation_object}+H_{brake_v}+Hₘᵢₙ (2)

wherein Hₗᵢₘᵢₜ is a flight-restriction vertical distance of a UAV under current flying speed;
H_{max_deviation_UA} is a maximum deviation in the UAV's altitude location data;
H_{max_deviation_object} is a maximum deviation in the stationary object's altitude location data;
H_{safety} is a height safety margin;
Hₘᵢₙ is a required minimum vertical distance between the UAV and the object of interest; and
H_{brake_h} is a vertical distance needed to stop the UAV (e.g., zero if the UAV is flying upward and away from the stationary object).

Hₗᵢₘᵢₜ is a flight restriction vertical distance of a UAV relative to an object of interest, such that the UAV is directed to maintain a vertical separation distance of at least the flight restriction vertical distance from the object of interest.

H_{max_deviation_UA} is a maximum deviation in the UAV's altitude location data. This deviation may be calculated as a range of values, measured under typical operating conditions of the UAV, corresponding to a difference between a UAV's measured altitude location data and its true altitude. The maximum deviation in the UAV's altitude location data may be the maximum value of this range of values corresponding to a difference between the UAV's measured altitude location data and its true altitude.

H_{max_deviation_object} is a maximum deviation in the object of interest's altitude location data. This deviation may be calculated as a range of values, measured under typical operating conditions of the object of interest, corresponding to a difference between an object of interest's measured altitude location data and its true altitude. The maximum deviation in the object of interest's altitude location data may be the maximum value of this range of values corresponding to a difference between the object of interest's measured altitude location data and its true altitude.

H_{safety} is a height safety margin. This height safety margin may be zero. This height safety margin may be predetermined for the UAV. This height safety margin may be calculated based on the UAV's operation mode and/or one or more parameters (e.g., speed). This height safety margin may be increased as the UAV's speed increases. This height safety margin may be predetermined for the object of interest. This height safety margin may be calculated based on one or more parameters of the object of interest (e.g., speed). This height safety margin may be increased as the object of interest's speed increases.

Hₘᵢₙ is a required minimum vertical distance between the UAV and the object of interest. This required minimum vertical distance may be zero. This required minimum vertical distance may be a predetermined value set by the UAV. This required minimum vertical distance may be a predetermined value set by the object of interest. This required minimum vertical distance may be a predetermined value set by one or more jurisdictional (e.g., local, national, or international) laws under which the UAV is bound. This required minimum vertical distance may be a predetermined value set by one or more jurisdictional laws (e.g., local, national, or international) under which the object of interest is bound.

H_{brake_h} is a vertical distance needed to stop the UAV. This vertical distance may be zero, e.g., if the UAV is flying away from the object of interest.

Hₗᵢₘᵢₜ may be calculated as a sum of two or more of these factors. Hₗᵢₘᵢₜ may be calculated as a weighted sum of two or more of these factors. A weight of the weighted sum may be a predetermined value. A weight of the weighted sum may be a value determined by a characteristic of the object of interest.

As previously described, an object of interest may be a stationary object or moving object. If the object of interest is a moving object, a flight-restriction region may be moving with the object of interest. For example, a three-dimensional flight-restriction region may be a moving region that may be defined based on a moving object to be avoided. The UAV may be directed to continually maintain at least a flight-restriction distance away from a moving object. To design a flight-restriction region for a moving object, a velocity vector may be added as compared to the approach for design of a flight-restriction region for stationary objects. For example, a UAV can descend to a safe height in a region outside the flight-restriction region when receiving a broadcast signal from a moving object. The flight-restriction region can be defined in consideration of information of low altitude radar or automatic dependent surveillance-broadcast (ADS-B), wide area multilateration (WAM) data.

A moving 2-D or 3-D flight-restriction region may be defined for a moving object to provide protection for the moving object (e.g., a large-scale aircraft), which may have a potential for a collision event with small-scale unmanned aircraft. A moving flight-restriction region may be designed for other types of manned or unmanned vehicles (e.g. ships, automobiles, trains). A moving flight-restriction region may be defined for a moving person (e.g., a VIP individual such as a political, business, or other organization leader).

A 3-D flight-restriction region for a moving object may be generated based on (1) a maximum possible delay t₁ in data acquisition (e.g., acquiring the coordinates and velocity direction) from the object of interest to be avoided, (2) a maximum possible delay t₂ in communication (e.g., to transmit data) to a UAV, and (3) a response time t₃ for the UAV (e.g., to leave the flight-restriction area), and (4) forward velocity v₁ of the object of interest.

The flight-restriction distance in forward direction may be calculated as:

S=(t₁+t₂+t₃)×v₁×n (3)

where n is a coefficient and can be adjusted in view of the priority of the object of interest to be avoided. This n provides a redundant protection by specifying a safety factor.

If the moving object is performing a non-linear movement (e.g., changing direction of movement by turning), then the flight-restriction distance may be calculated as:

S2=v₁×(t₁+t₂+t₃−w/α)×n

where α is an angle between the UAV and the flight direction of the object of interest, and w is an angular velocity of the object of interest in changing the direction. FIG. 6 illustrates an example of a flight-restriction distance and altitude of a UAV from an object of interest moving away from the UAV, in accordance with an embodiment of the disclosure. This flight-restriction distance may be determined for all directions of the object of interest, to accommodate cases in which the system does not timely detect a velocity change of the object of interest.

A safety factor n may be used to adjust the flight-restriction distance based on a number of safety considerations. A greater value to the safety factor will result in a greater flight-restriction distance. The safety considerations may include classification of the object of interest, for example a classification chosen from: a UAV, a commercial aircraft, a private aircraft, a freight train, a passenger train, a bus, a freight truck, a fire engine, an ambulance, a car or similar vehicle, a bicycle, a person, an airport, a nuclear facility, a shopping mall, a department store, a grocery store, a restaurant. For instance, the safety factor can be provided as a value based on the classification of the object of interest. The safety factor may be larger when the level of priority of the object of interest is higher (e.g., an airport or a government building) than when the level of priority of the object of interest is lower (e.g., an office building or a private citizen's home). The safety factor may be larger when the object of interest is a moving person. The safety factor may be larger when the moving person is of high priority (e.g., a VIP individual such as a political, business, or other organization leader) than when the moving person is of lower priority (e.g., one or more private citizens).

If the angular velocity of the object of interest is very small, resulting in a very small or even a negative S2, then the flight-restriction distance should be at least n times the length 1 of the object of interest. Illustrative examples of calculations to determine a flight-restriction region of a moving object are provided in Examples 1 and 2.

### Example 1

An automobile, which carries a VIP, travels at a speed of 20 meters per second (m/s) forward. The safety factor n is 5. The maximum possible delay in acquiring the coordinates of the automobile is 500 milliseconds (ms). The maximum possible delay in transmitting data to the UAV is 100 ms. The velocity of the UAV is 5 m/s. The response time for UAV is 7 seconds (s) (e.g., respond in 2 s, brake in 2 s, and leave in 3 s).

The flight-restriction distance in a forward direction relative to the automobile's movement is S=20×7.6×5=760 meters (m).

If the automobile changes its direction at an angular velocity of 30 degrees per second, then the flight-restriction distance at a position which forms an angle a with respect to the moving direction of the automobile is S2=20×(7.6−α/30)×5.

The flight-restriction distance in the backward direction is 160 m.

### Example 2

A civil aircraft, having a length of 40 m, is descending in a downward direction of −15 degrees at a velocity of 200 m/s. The safety factor n is 4. The delay in acquiring the ADS0-B data is 100 ms. The delay in the UAV data link is 100 ms. The velocity of the UAV is 5 m/s. The response time for UAV is 12 s (e.g., respond in 2 s, brake in 2 s, and leave in 8 s).

Then the flight-restriction distance in a downward direction of −15 degrees is: S=200×12.3×4=9840 s.

If the angular velocity of the civil aircraft in pitch direction is 4 degrees/s, and the maximum yaw velocity of the civil aircraft is 10 degrees/s, then the flight-restriction distance in a horizontal direction and vertical direction in 3-D space (e.g., volume) can be accordingly calculated.

Since a long time is needed for the aircraft to turn around, the flight-restriction distance in the backward direction of the aircraft is 160 m, which is three times the length of the aircraft.

If loss of communication is experienced (e.g., between the UAV and an object of interest), for instance if a network or broadcast signal is lost, then the moving direction and velocity of a moving object can be predicted. For instance if the object of interest is a commercial aircraft, it is not likely for a commercial aircraft to deviate from the scheduled path, therefore the moving direction and velocity of the commercial aircraft can be continuously predicted by referring to the scheduled path. Similarly if the object of interest is a train, the object of interest is almost certainly not going to deviate from the scheduled path, thereby the moving direction and velocity can be continuously predicted over time in the event of detected communication loss or interruption. For instance if the moving object is a civil aircraft, the civil aircraft may have a chance of deviating from the scheduled path (e.g., either intentional due to pilot control or unintentional due to aircraft malfunction or weather conditions), which may necessitate the increasing of the safety factor in the event of detected communication loss or interruption. For instance if the moving object is a car, the car's scheduled path may be predicted from a GPS navigation unit configured by the driver of the car.

One or more parameters may also be estimated in the event of loss of signal or malfunction of one or more sensors. For instance if an altimeter signal is temporarily lost, such location data may be acquired instead through GNSS. For instance if location data from GNSS is temporarily lost, such location data may be indirectly calculated through a combination of previous location data, velocity data, accelerometer data, and/or compass data.

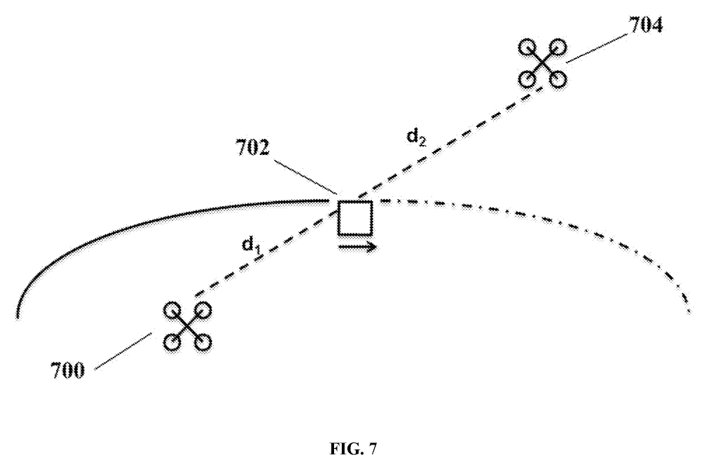

FIG. 7 illustrates an example of a predicted flight-restriction region of a UAV during loss of communication between a UAV and an object of interest, in accordance with an embodiment of the disclosure. A UAV 700 may maintain at least a flight-restriction distance d₁ from a moving object 702, the moving object having a velocity away from the UAV. A UAV 704 may maintain at least a flight-restriction distance d₂ from a moving object 702, the moving object having a velocity toward the UAV. The moving object 702 may be moving in a predefined or predictable trajectory (e.g., as shown by the solid curve), such that the trajectory can be estimated or predicted (e.g., as shown by the dashed curve) after a loss or interruption of communication is detected.

### Computer Control Systems

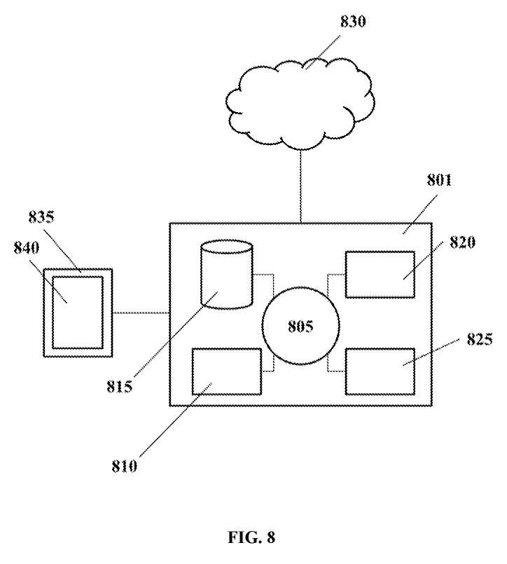

Computer control systems are provided that are programmed to implement methods of the disclosure. FIG. 8 shows a computer system 801 that is programmed or otherwise configured to implement methods for controlling flight of a UAV. The computer system 801 can regulate various aspects of the present disclosure, such as, for example, methods for controlling flight of a UAV. The computer system 801 can be an electronic device of a user or a computer system that is remotely located with respect to the electronic device. The electronic device can be a mobile electronic device.

The computer system 801 includes a central processing unit (CPU, also “processor” and “computer processor” herein) 805, which can be a single core or multi core processor, or a plurality of processors for parallel processing. The computer system 801 also includes memory or memory location 810 (e.g., random-access memory, read-only memory, flash memory), electronic storage unit 815 (e.g., hard disk), communication interface 820 (e.g., network adapter) for communicating with one or more other systems, and peripheral devices 825, such as cache, other memory, data storage and/or electronic display adapters. The memory 810, storage unit 815, interface 820 and peripheral devices 825 are in communication with the CPU 705 through a communication bus (solid lines), such as a motherboard. The storage unit 815 can be a data storage unit (or data repository) for storing data. The computer system 801 can be operatively coupled to a computer network (“network”) 830 with the aid of the communication interface 820. The network 830 can be the Internet, an internet and/or extranet, or an intranet and/or extranet that is in communication with the Internet. The network 830 in some cases is a telecommunication and/or data network. The network 830 can include one or more computer servers, which can enable distributed computing, such as cloud computing. The network 830, in some cases with the aid of the computer system 801, can implement a peer-to-peer network, which may enable devices coupled to the computer system 801 to behave as a client or a server.

The CPU 805 can execute a sequence of machine-readable instructions, which can be embodied in a program or software. The instructions may be stored in a memory location, such as the memory 810. The instructions can be directed to the CPU 705, which can subsequently program or otherwise configure the CPU 805 to implement methods of the present disclosure. Examples of operations performed by the CPU 805 can include fetch, decode, execute, and writeback.

The CPU 805 can be part of a circuit, such as an integrated circuit. One or more other components of the system 801 can be included in the circuit. The CPU may be integrated into an object of interest, on-board an object of interest, integrated into a UAV, on-board a UAV, or part of a communication channel (e.g., cloud network). In some cases, the circuit is an application specific integrated circuit (ASIC).

The storage unit 815 can store files, such as drivers, libraries and saved programs. The storage unit 815 can store user data, e.g., user preferences and user programs. The computer system 801 in some cases can include one or more additional data storage units that are external to the computer system 801, such as located on a remote server that is in communication with the computer system 801 through an intranet or the Internet. The storage unit may be integrated into an object of interest, on-board an object of interest, integrated into a UAV, on-board a UAV, or part of a communication channel (e.g., cloud network). The storage unit may store a flight-restriction database.

The computer system 801 can communicate with one or more remote computer systems through the network 830. For instance, the computer system 801 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 801 via the network 830. The network may comprise a wireless communication network (e.g., a cloud network).

Methods as described herein can be implemented by way of machine (e.g., computer processor) executable code stored on an electronic storage location of the computer system 801, such as, for example, on the memory 810 or electronic storage unit 815. The machine executable or machine readable code can be provided in the form of software (e.g., a computer software or a mobile application such as cell phone app). During use, the code can be executed by the processor 805. In some cases, the code can be retrieved from the storage unit 815 and stored on the memory 810 for ready access by the processor 805. In some situations, the electronic storage unit 815 can be precluded, and machine-executable instructions are stored on memory 810.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 801, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 801 can include or be in communication with an electronic display 835 that comprises a user interface (UI) 840 for providing, for example, input parameters for methods of UAV flight restriction for stationary and moving objects. Examples of UIs include, without limitation, a graphical user interface (GUI) and web-based user interface. The UI may be part of a UAV's remote control. The UI may be part of an object of interest and controlled by the object of interest's user.

Methods and systems of the present disclosure can be implemented by way of one or more algorithms. An algorithm can be implemented by way of software upon execution by the central processing unit 805. The algorithm can, for example, control flight of a UAV.

### UAVs

The systems, devices, and methods described herein can be applied to a wide variety of moving objects. As previously mentioned, any description herein of a UAV may apply to and be used for any moving object. Any description herein of a UAV may apply to any aerial vehicle. A moving object of the present disclosure can be configured to move within any suitable environment, such as in air (e.g., a fixed-wing aircraft, a rotary-wing aircraft, or an aircraft having neither fixed wings nor rotary wings), in water (e.g., a ship or a submarine), on ground (e.g., a motor vehicle, such as a car, truck, bus, van, motorcycle, bicycle; a movable structure or frame such as a stick, fishing pole; or a train), under the ground (e.g., a subway), in space (e.g., a spaceplane, a satellite, or a probe), or any combination of these environments. The moving object can be a vehicle, such as a vehicle described elsewhere herein. In some embodiments, the moving object can be carried by a living subject, or take off from a living subject, such as a human or an animal. Suitable animals can include avines, canines, felines, equines, bovines, ovines, porcines, delphines, rodents, or insects.

The moving object may be capable of moving freely within the environment with respect to six degrees of freedom (e.g., three degrees of freedom in translation and three degrees of freedom in rotation). Alternatively, the movement of the moving object can be constrained with respect to one or more degrees of freedom, such as by a predetermined path, track, or orientation. The movement can be actuated by any suitable actuation mechanism, such as an engine or a motor. The actuation mechanism of the moving object can be powered by any suitable energy source, such as electrical energy, magnetic energy, solar energy, wind energy, gravitational energy, chemical energy, nuclear energy, or any suitable combination thereof. The moving object may be self-propelled via a propulsion system, as described elsewhere herein. The propulsion system may optionally run on an energy source, such as electrical energy, magnetic energy, solar energy, wind energy, gravitational energy, chemical energy, nuclear energy, or any suitable combination thereof. Alternatively, the moving object may be carried by a living being.

In some instances, the moving object can be a vehicle. Suitable vehicles may include water vehicles, aerial vehicles, space vehicles, or ground vehicles. For example, aerial vehicles may be fixed-wing aircraft (e.g., airplane, gliders), rotary-wing aircraft (e.g., helicopters, rotorcraft), aircraft having both fixed wings and rotary wings, or aircraft having neither (e.g., blimps, hot air balloons). A vehicle can be self-propelled, such as self-propelled through the air, on or in water, in space, or on or under the ground. A self-propelled vehicle can utilize a propulsion system, such as a propulsion system including one or more engines, motors, wheels, axles, magnets, rotors, propellers, blades, nozzles, or any suitable combination thereof. In some instances, the propulsion system can be used to enable the moving object to take off from a surface, land on a surface, maintain its current position and/or orientation (e.g., hover), change orientation, and/or change position.

The moving object can be controlled remotely by a user or controlled locally by an occupant within or on the moving object. In some embodiments, the moving object is an unmanned moving object, such as a UAV. An unmanned moving object, such as a UAV, may not have an occupant onboard the moving object. The moving object can be controlled by a human or an autonomous control system (e.g., a computer control system), or any suitable combination thereof. The moving object can be an autonomous or semi-autonomous robot, such as a robot configured with an artificial intelligence.

The moving object can have any suitable size and/or dimensions. In some embodiments, the moving object may be of a size and/or dimensions to have a human occupant within or on the vehicle. Alternatively, the moving object may be of size and/or dimensions smaller than that capable of having a human occupant within or on the vehicle. The moving object may be of a size and/or dimensions suitable for being lifted or carried by a human. Alternatively, the moving object may be larger than a size and/or dimensions suitable for being lifted or carried by a human. In some instances, the moving object may have a maximum dimension (e.g., length, width, height, diameter, diagonal) of less than or equal to about: 2 cm, 5 cm, 10 cm, 50 cm, 1 m, 2 m, 5 m, or 10 m. The maximum dimension may be greater than or equal to about: 2 cm, 5 cm, 10 cm, 50 cm, 1 m, 2 m, 5 m, or 10 m. For example, the distance between shafts of opposite rotors of the moving object may be less than or equal to about: 2 cm, 5 cm, 10 cm, 50 cm, 1 m, 2 m, 5 m, or 10 m. Alternatively, the distance between shafts of opposite rotors may be greater than or equal to about: 2 cm, 5 cm, 10 cm, 50 cm, 1 m, 2 m, 5 m, or 10 m.

In some embodiments, the moving object may have a volume of less than 100 cm×100 cm×100 cm, less than 50 cm×50 cm×30 cm, or less than 5 cm×5 cm×3 cm. The total volume of the moving object may be less than or equal to about: 1 cm³, 2 cm³, 5 cm³, 10 cm³, 20 cm³, 30 cm³, 40 cm³, 50 cm³, 60 cm³, 70 cm³, 80 cm³, 90 cm³, 100 cm³, 150 cm³, 200 cm³, 300 cm³, 500 cm³, 750 cm³, 1000 cm³, 5000 cm³, 10,000 cm³, 100,000 cm³, 1 m³, or 10 m³.

Conversely, the total volume of the moving object may be greater than or equal to about: 1 cm³, 2 cm³, 5 cm³, 10 cm³, 20 cm³, 30 cm³, 40 cm³, 50 cm³, 60 cm³, 70 cm³, 80 cm³, 90 cm³, 100 cm³, 150 cm³, 200 cm³, 300 cm³, 500 cm³, 750 cm³, 1000 cm³, 5000 cm³, 10,000 cm³, 100,000 cm³, 1 m³, or 10 m³.

In some embodiments, the moving object may have a footprint (which may refer to the lateral cross-sectional area encompassed by the moving object) less than or equal to about: 32,000 cm², 20,000 cm², 10,000 cm², 1,000 cm², 500 cm², 100 cm², 50 cm², 10 cm², or 5 cm². Conversely, the footprint may be greater than or equal to about: 32,000 cm², 20,000 cm², 10,000 cm², 1,000 cm², 500 cm², 100 cm², 50 cm², 10 cm², or 5 cm².

In some instances, the moving object may weigh no more than 1000 kg. The weight of the moving object may be less than or equal to about: 1000 kg, 750 kg, 500 kg, 200 kg, 150 kg, 100 kg, 80 kg, 70 kg, 60 kg, 50 kg, 45 kg, 40 kg, 35 kg, 30 kg, 25 kg, 20 kg, 15 kg, 12 kg, 10 kg, 9 kg, 8 kg, 7 kg, 6 kg, 5 kg, 4 kg, 3 kg, 2 kg, 1 kg, 0.5 kg, 0.1 kg, 0.05 kg, or 0.01 kg. Conversely, the weight may be greater than or equal to about: 1000 kg, 750 kg, 500 kg, 200 kg, 150 kg, 100 kg, 80 kg, 70 kg, 60 kg, 50 kg, 45 kg, 40 kg, 35 kg, 30 kg, 25 kg, 20 kg, 15 kg, 12 kg, 10 kg, 9 kg, 8 kg, 7 kg, 6 kg, 5 kg, 4 kg, 3 kg, 2 kg, 1 kg, 0.5 kg, 0.1 kg, 0.05 kg, or 0.01 kg.

In some embodiments, a moving object may be small relative to a load carried by the moving object. The load may include a payload and/or a carrier, as described in further detail elsewhere herein. In some examples, a ratio of a moving object weight to a load weight may be greater than, less than, or equal to about 1:1. In some instances, a ratio of a moving object weight to a load weight may be greater than, less than, or equal to about 1:1. Optionally, a ratio of a carrier weight to a load weight may be greater than, less than, or equal to about 1:1. When desired, the ratio of an moving object weight to a load weight may be less than or equal to: 1:2, 1:3, 1:4, 1:5, 1:10, or even less. Conversely, the ratio of a moving object weight to a load weight can also be greater than or equal to: 2:1, 3:1, 4:1, 5:1, 10:1, or even greater.

In some embodiments, the moving object may have low energy consumption. For example, the moving object may use less than about: 5 W/h, 4 W/h, 3 W/h, 2 W/h, 1 W/h, or less. In some instances, a carrier of the moving object may have low energy consumption. For example, the carrier may use less than about: 5 W/h, 4 W/h, 3 W/h, 2 W/h, 1 W/h, or less. Optionally, a payload of the moving object may have low energy consumption, such as less than about: 5 W/h, 4 W/h, 3 W/h, 2 W/h, 1 W/h, or less.

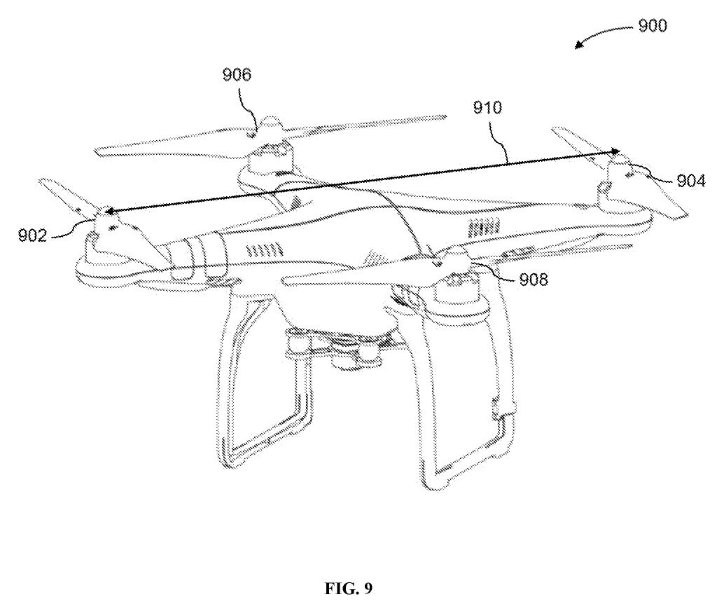

FIG. 9 illustrates an unmanned aerial vehicle (UAV) 900, in accordance with embodiments of the present disclosure. The UAV may be an example of a moving object as described herein. The UAV 900 can include a propulsion system having four rotors 902, 904, 906, and 908. Any number of rotors may be provided (e.g., one, two, three, four, five, six, or more). The rotors, rotor assemblies, or other propulsion systems of the unmanned aerial vehicle may enable the unmanned aerial vehicle to hover/maintain position, change orientation, and/or change location. The distance between shafts of opposite rotors can be any suitable length 910. For example, the length 910 can be less than or equal to 2 m, or less than equal to 11 m. In some embodiments, the length 910 can be within a range from 40 cm to 7 m, from 70 cm to 2 m, or from 11 cm to 11 m. Any description herein of a UAV may apply to a moving object, such as a moving object of a different type, and vice versa. The UAV may use an assisted takeoff system or method as described herein.

In some embodiments, the moving object can be configured to carry a load. The load can include one or more of passengers, cargo, equipment, instruments, and the like. The load can be provided within a housing. The housing may be separate from a housing of the moving object, or be part of a housing for an moving object. Alternatively, the load can be provided with a housing while the moving object does not have a housing. Alternatively, portions of the load or the entire load can be provided without a housing. The load can be rigidly fixed relative to the moving object. Optionally, the load can be movable relative to the moving object (e.g., translatable or rotatable relative to the moving object). The load can include a payload and/or a carrier, as described elsewhere herein.

In some embodiments, the movement of the moving object, carrier, and payload relative to a fixed reference frame (e.g., the surrounding environment) and/or to each other, can be controlled by a terminal. The terminal can be a remote control device at a location distant from the moving object, carrier, and/or payload. The terminal can be disposed on or affixed to a support platform. Alternatively, the terminal can be a handheld or wearable device. For example, the terminal can include a smartphone, tablet, laptop, computer, glasses, gloves, helmet, microphone, or suitable combinations thereof. The terminal can include a user interface, such as a keyboard, mouse, joystick, touchscreen, or display. Any suitable user input can be used to interact with the terminal, such as manually entered commands, voice control, gesture control, or position control (e.g., via a movement, location or tilt of the terminal).

The terminal can be used to control any suitable state of the moving object, carrier, and/or payload. For example, the terminal can be used to control the position and/or orientation of the moving object, carrier, and/or payload relative to a fixed reference from and/or to each other. In some embodiments, the terminal can be used to control individual elements of the moving object, carrier, and/or payload, such as the actuation assembly of the carrier, a sensor of the payload, or an emitter of the payload. The terminal can include a wireless communication device adapted to communicate with one or more of the moving object, carrier, or payload.

The terminal can include a suitable display unit for viewing information of the moving object, carrier, and/or payload. For example, the terminal can be configured to display information of the moving object, carrier, and/or payload with respect to position, translational velocity, translational acceleration, orientation, angular velocity, angular acceleration, or any suitable combinations thereof. In some embodiments, the terminal can display information provided by the payload, such as data provided by a functional payload (e.g., images recorded by a camera or other image capturing device).

Optionally, the same terminal may both control the moving object, carrier, and/or payload, or a state of the moving object, carrier and/or payload, as well as receive and/or display information from the moving object, carrier and/or payload. For example, a terminal may control the positioning of the payload relative to an environment, while displaying image data captured by the payload, or information about the position of the payload. Alternatively, different terminals may be used for different functions. For example, a first terminal may control movement or a state of the moving object, carrier, and/or payload while a second terminal may receive and/or display information from the moving object, carrier, and/or payload. For example, a first terminal may be used to control the positioning of the payload relative to an environment while a second terminal displays image data captured by the payload. Various communication modes may be utilized between a moving object and an integrated terminal that both controls the moving object and receives data, or between the moving object and multiple terminals that both control the moving object and receives data. For example, at least two different communication modes may be formed between the moving object and the terminal that both controls the moving object and receives data from the moving object.

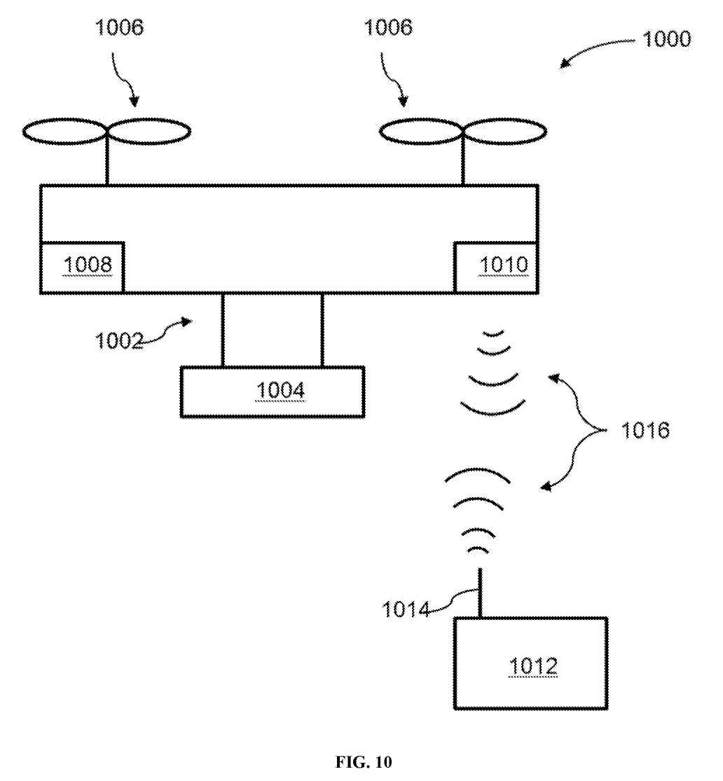

FIG. 10 illustrates a UAV 1000 including a carrier 1002 and a payload 1004, in accordance with embodiments. Although the moving object 1000 is depicted as an aircraft, this depiction is not intended to be limiting, and any suitable type of moving vehicle can be used, as previously described herein. One of skill in the art would appreciate that any of the embodiments described herein in the context of UAVs can be applied to any suitable moving object. In some instances, the payload 1004 may be provided on the UAV 1000 without requiring the carrier 1002. The moving object 1000 may include propulsion mechanisms 1006, a sensing system 1008, and a communication system 1010.

The propulsion mechanisms 1006 can include one or more of rotors, propellers, blades, engines, motors, wheels, axles, magnets, or nozzles, as previously described. The moving object may have one or more, two or more, three or more, or four or more propulsion mechanisms. The propulsion mechanisms may all be of the same type. Alternatively, one or more propulsion mechanisms can be different types of propulsion mechanisms. The propulsion mechanisms 1006 can be mounted on the UAV 1000 using any suitable means, such as a support element (e.g., a drive shaft) as described elsewhere herein. The propulsion mechanisms 1006 can be mounted on any suitable portion of the UAV 1000, such on the top, bottom, front, back, sides, or suitable combinations thereof.

In some embodiments, the propulsion mechanisms 1006 can enable the UAV 1000 to take off vertically from a surface or land vertically on a surface without requiring any horizontal movement of the UAV 1000 (e.g., without traveling down a runway). Optionally, the propulsion mechanisms 1006 can be operable to permit the UAV 1000 to hover in the air at a specified position and/or orientation. One or more of the propulsion mechanisms 1000 may be controlled independently of the other propulsion mechanisms. Alternatively, the propulsion mechanisms 1000 can be configured to be controlled simultaneously. For example, the UAV 1000 can have multiple horizontally oriented rotors that can provide lift and/or thrust to the UAV. The multiple horizontally oriented rotors can be actuated to provide vertical takeoff, vertical landing, and hovering capabilities to the UAV 1000. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the UAV 1000 (e.g., with respect to up to three degrees of translation and up to three degrees of rotation).

The sensing system 1008 can include one or more sensors that may sense the spatial disposition, velocity, and/or acceleration of the UAV 1000 (e.g., with respect to up to three degrees of translation and up to three degrees of rotation). The one or more sensors can include global positioning system (GPS) sensors, motion sensors, inertial sensors, proximity sensors, or image sensors. The sensing data provided by the sensing system 1008 can be used to control the spatial disposition, velocity, and/or orientation of the UAV 1000 (e.g., using a suitable processing unit and/or control module, as described below). Alternatively, the sensing system 1008 can be used to provide data regarding the environment surrounding the UAV, such as weather conditions, proximity to potential obstacles, location of geographical features, location of manmade structures, and the like.

The communication system 1010 enables communication with terminal 1012 having a communication system 1014 via wireless signals 1016. The communication systems 1010, 1014 may include any number of transmitters, receivers, and/or transceivers suitable for wireless communication. The communication may be one-way communication, such that data can be transmitted in only one direction. For example, one-way communication may involve only the UAV 1000 transmitting data to the terminal 1012, or vice-versa. The data may be transmitted from one or more transmitters of the communication system 1010 to one or more receivers of the communication system 1012, or vice-versa. Alternatively, the communication may be two-way communication, such that data can be transmitted in both directions between the UAV 1000 and the terminal 1012. The two-way communication can involve transmitting data from one or more transmitters of the communication system 1010 to one or more receivers of the communication system 1014, and vice-versa.

In some embodiments, the terminal 1012 can provide control data to one or more of the UAV 1000, carrier 1002, and payload 1004 and receive information from one or more of the UAV 1000, carrier 1002, and payload 1004 (e.g., position and/or motion information of the UAV, carrier or payload; data sensed by the payload such as image data captured by a payload camera). In some instances, control data from the terminal may include instructions for relative positions, movements, actuations, or controls of the UAV, carrier and/or payload. For example, the control data may result in a modification of the location and/or orientation of the UAV (e.g., via control of the propulsion mechanisms 1006), or a movement of the payload with respect to the UAV (e.g., via control of the carrier 1002). The control data from the terminal may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view). In some instances, the communications from the UAV, carrier and/or payload may include information from one or more sensors (e.g., of the sensing system 1008 or of the payload 1004). The communications may include sensed information from one or more different types of sensors (e.g., GPS sensors, motion sensors, inertial sensor, proximity sensors, or image sensors). Such information may pertain to the position (e.g., location, orientation), movement, or acceleration of the UAV, carrier and/or payload. Such information from a payload may include data captured by the payload or a sensed state of the payload. The control data provided transmitted by the terminal 1012 can be configured to control a state of one or more of the UAV 1000, carrier 1002, or payload 1004. Alternatively or in combination, the carrier 1002 and payload 1004 can also each include a communication module configured to communicate with terminal 1012, such that the terminal can communicate with and control each of the UAV 1000, carrier 1002, and payload 1004 independently.

In some embodiments, the UAV 1000 can be configured to communicate with another remote device in addition to the terminal 1012, or instead of the terminal 1012. The terminal 1012 may also be configured to communicate with another remote device as well as the UAV 1000. For example, the UAV 1000 and/or terminal 1012 may communicate with another UAV, or a carrier or payload of another UAV. When desired, the remote device may be a second terminal or other computing device (e.g., computer, laptop, tablet, smartphone, or other mobile device). The remote device can be configured to transmit data to the UAV 1000, receive data from the UAV 1000, transmit data to the terminal 1012, and/or receive data from the terminal 1012. Optionally, the remote device can be connected to the Internet or other telecommunications network, such that data received from the UAV 1000 and/or terminal 1012 can be uploaded to a website or server.

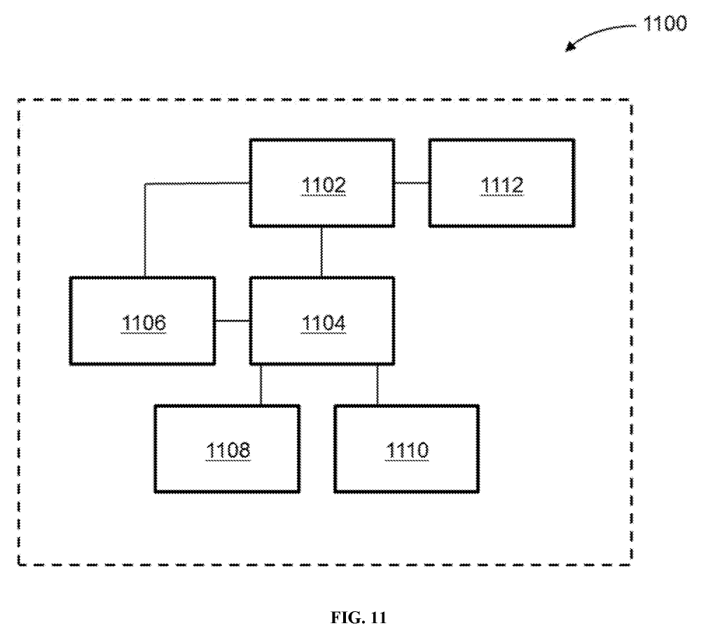

FIG. 11 is a schematic illustration by way of block diagram of a system 1100 for controlling a UAV, in accordance with embodiments. The system 1100 can be used in combination with any suitable embodiment of the systems, devices, and methods disclosed herein. The system 1100 can include a sensing module 1102, processing unit 1104, non-transitory computer readable medium 1106, control module 1108, and communication module 1110.

The sensing module 1102 can utilize different types of sensors that collect information relating to the UAVs in different ways. Different types of sensors may sense different types of signals or signals from different sources. For example, the sensors can include inertial sensors, GPS sensors, proximity sensors (e.g., lidar), or vision/image sensors (e.g., a camera). The sensing module 1102 can be operatively coupled to a processing unit 1104 having a plurality of processors. In some embodiments, the sensing module can be operatively coupled to a transmission module 1112 (e.g., a Wi-Fi image transmission module) configured to directly transmit sensing data to a suitable external device or system. For example, the transmission module 1112 can be used to transmit images captured by a camera of the sensing module 1102 to a remote terminal.

The processing unit 1104 can have one or more processors, such as a programmable processor (e.g., a central processing unit (CPU)). The processing unit 1104 can be operatively coupled to a non-transitory computer readable medium 1106. The non-transitory computer readable medium 1106 can store logic, code, and/or program instructions executable by the processing unit 1104 for performing one or more steps. The non-transitory computer readable medium can include one or more memory units (e.g., removable media or external storage such as an SD card or random access memory (RAM)). In some embodiments, data from the sensing module 1102 can be directly conveyed to and stored within the memory units of the non-transitory computer readable medium 1106. The memory units of the non-transitory computer readable medium 1106 can store logic, code and/or program instructions executable by the processing unit 1104 to perform any suitable embodiment of the methods described herein. For example, the processing unit 1104 can be configured to execute instructions causing one or more processors of the processing unit 1104 to analyze sensing data produced by the sensing module. The memory units can store sensing data from the sensing module to be processed by the processing unit 1104. In some embodiments, the memory units of the non-transitory computer readable medium 1106 can be used to store the processing results produced by the processing unit 1104.

In some embodiments, the processing unit 1104 can be operatively coupled to a control module 1108 configured to control a state of the UAV. For example, the control module 1108 can be configured to control the propulsion mechanisms of the UAV to adjust the spatial disposition, velocity, and/or acceleration of the UAV with respect to six degrees of freedom. Alternatively or in combination, the control module 1108 can control one or more of a state of a carrier, payload, or sensing module.

The processing unit 1104 can be operatively coupled to a communication module 1110 configured to transmit and/or receive data from one or more external devices (e.g., a terminal, display device, or other remote controller). Any suitable means of communication can be used, such as wired communication or wireless communication. For example, the communication module 1110 can utilize one or more of local area networks (LAN), wide area networks (WAN), infrared, radio, WiFi, point-to-point (P2P) networks, telecommunication networks, cloud communication, and the like. Optionally, relay stations, such as towers, satellites, or mobile stations, can be used. Wireless communications can be proximity dependent or proximity independent. In some embodiments, line-of-sight may or may not be required for communications. The communication module 1110 can transmit and/or receive one or more of sensing data from the sensing module 1102, processing results produced by the processing unit 1104, predetermined control data, user commands from a terminal or remote controller, and the like.

The components of the system 1100 can be arranged in any suitable configuration. For example, one or more of the components of the system 1100 can be located on the UAV, carrier, payload, terminal, sensing system, or an additional external device in communication with one or more of the above. Additionally, although FIG. 11 depicts a single processing unit 1104 and a single non-transitory computer readable medium 1106, one of skill in the art would appreciate that this is not intended to be limiting, and that the system 1100 can include a plurality of processing units and/or non-transitory computer readable media. In some embodiments, one or more of the plurality of processing units and/or non-transitory computer readable media can be situated at different locations, such as on the UAV, carrier, payload, terminal, sensing module, additional external device in communication with one or more of the above, or suitable combinations thereof, such that any suitable aspect of the processing and/or memory functions performed by the system 1100 can occur at one or more of the aforementioned locations.

While some embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the disclosure shall also cover any such alternatives, modifications, variations or equivalents. It is intended that the following claims define the scope of the invention and that methods and structures within the scope of these claims and their equivalents be covered thereby.

What is claimed is:

1. A method for controlling flight of an unmanned aerial vehicle (UAV), the method comprising:
obtaining information about a location of an object of interest;
calculating, during operation of the UAV, a flight-restricted distance for the UAV to maintain relative to the object of interest, wherein the flight-restricted distance is calculated based on a safety factor, wherein the safety factor is determined based on an object classification; and
controlling flight of the UAV to maintain the flight-restricted distance relative to the object of interest.

2. The method of claim 1, wherein the object classification is indicative of a type of object of interest, wherein the type of object of interest is selected from a plurality of types of objects of interest.

3. The method of claim 1, wherein the object classification is indicative of a movement characteristic of the object of interest, wherein the safety factor corresponds to the object of interest's speed capability.

4. The method of claim 1, wherein the object classification is indicative of a priority associated with the object of interest, wherein the safety factor corresponds to the priority.

5. The method of claim 1, wherein the flight-restricted distance is calculated as a weighted sum of one or more of:
(i) a distance safety margin;
(ii) a maximum deviation in the UAV's location data;
(iii) a maximum deviation in the object of interest's location data;
(iv) a required minimum distance between the UAV and the object of interest; and
(v) a braking distance needed to stop the UAV.

6. The method of claim 1, wherein the flight-restricted distance is a flight-restricted height for the UAV to maintain relative to the object of interest, wherein the safety factor is a height safety factor determined based on the object classification.

7. The method of claim 6, wherein the flight-restricted height is calculated as a weighted sum of one or more of:
(i) a height safety margin;
(ii) a maximum deviation in the UAV's height data;
(iii) a maximum deviation in the object of interest's height data;
(iv) a required minimum height distance between the UAV and the object of interest; and
(v) a braking height distance needed to stop the UAV.

8. The method of claim 1, wherein the flight-restricted distance is indicative of a distance to a boundary of a flight-restriction region surrounding the object of interest, wherein the boundary of the flight restriction regions surrounding the object of interest is variable.

9. The method of claim 1, wherein the information about the location of the object of interest is broadcast from the object of interest at one or more time points.

10. The method of claim 1, wherein the information about the location of the object of interest is associated with the location of the object of interest at a time point and comprises one or more of: latitude, longitude, altitude, speed, and direction.

11. The method of claim 1, wherein controlling the flight of the UAV to maintain the flight-restricted distance relative to the object of interest comprises obtaining information about a location of the UAV.

12. The method of claim 11, wherein the information about the location of the UAV is associated with the location of the UAV at a time point and comprises one or more of: latitude, longitude, altitude, speed, and direction.

13. The method of claim 1, wherein controlling the flight of the UAV comprises performing a flight response measure.

14. The method of claim 13, wherein the flight response measure is selected from the group consisting of: changing speed, changing direction, changing acceleration, changing altitude, landing, and returning to a predetermined location.

15. An apparatus for controlling flight of an unmanned aerial vehicle (UAV), the apparatus comprising:
one or more processors configured to:
obtain information about a location of an object of interest;
calculate, during operation of the UAV, a flight-restricted distance for the UAV to maintain relative to the object of interest, wherein the flight-restricted distance is calculated based on a safety factor, wherein the safety factor is determined based on an object classification; and
control flight of the UAV to maintain the flight-restricted distance relative to the object of interest.

16. The apparatus of claim 15, wherein the object classification is indicative of a type of object of interest, wherein the type of object of interest is selected from a plurality of types of objects of interest.

17. The apparatus of claim 15, wherein the object classification is indicative of a movement characteristic of the object of interest.

18. The apparatus of claim 17, wherein the safety factor corresponds to the object of interest's speed capability.

19. The apparatus of claim 15, wherein the flight-restricted distance is calculated as a weighted sum of one or more of:
(i) a distance safety margin;
(ii) a maximum deviation in the UAV's location data;
(iii) a maximum deviation in the object of interest's location data;
(iv) a required minimum distance between the UAV and the object of interest; and
(v) a braking distance needed to stop the UAV.

20. A method for controlling flight of an unmanned aerial vehicle (UAV), the method comprising:
obtaining information about a location of an object of interest;
calculating, during operation of the UAV, a flight-restricted distance for the UAV to maintain relative to the object of interest, wherein the flight-restricted distance is calculated based on (1) a communication delay between the object of interest and the UAV, or (2) a data acquisition delay at the object of interest in providing the information about the location of the object of interest; and
controlling flight of the UAV to maintain the flight-restricted distance relative to the object of interest.
